(19) United States
(12) Patent Application Publication
(10) Pub. No.: US 2022/0347766 A1
(43) Pub. Date: Nov. 3, 2022

(54) DRILL GUIDE WITH CANTING BASE AND DOWEL JIG ATTACHMENTS

(71) Applicant: Charles Hadley Cammack, Lenexa, KS (US)

(72) Inventor: Charles Hadley Cammack, Lenexa, KS (US)

(21) Appl. No.: 17/856,218

(22) Filed: Jul. 1, 2022

Related U.S. Application Data
(63) Continuation-in-part of application No. 16/778,616, filed on Jan. 31, 2020, now Pat. No. 11,383,308.
(60) Provisional application No. 62/814,170, filed on Mar. 5, 2019.

(51) Int. Cl. B23B 47/28

(52) U.S. Cl. CPC B23B 47/288

(57) ABSTRACT

This invention includes a drill guide (drill depth stop and alignment tool), canting base attachment, and self-aligning dowel jig attachment that allows users to drill holes to prescribed depths into flat work surfaces using various sizes of twist and auger bits while eliminating marring and reducing wood splintering. The canting base attachment allows users to drill holes to prescribed depths and at variable angles into flat surfaces and both large and small cylinders with no free ends using various kinds and sizes of drilling tools without marring. The dowel jig attachment allows users to drill dowel holes to prescribed depths in edges and faces of work pieces that are evenly spaced apart by numerous gauged distances and at infinitely adjustable distances from edges. This invention has drill press-like capabilities and can be used in the field and in shops.

### RELATED APPLICATIONS

This application is a continuation-in-part (CIP), and claims priority benefit of all common subject matter, of U.S. Nonprovisional patent application Ser. No. 16/778,616 filed on 31 Jan. 2020. Application Ser. No. 16/778,616 claims priority benefit of U.S. Provisional Patent Application Ser. No. 62/814,170 filed 5 Mar. 2019. Application Ser. No. 16/778,616 and Application Ser. No. 62/814,170 are incorporated by reference herein in their entireties.

### BACKGROUND

Conventional drilling assist system include drill depth stops composed of cylinders (collars) having interior diameters only slightly larger than the constant diameter bits to which they are attached. U.S. Pat. No. 5,382,120 calls for a collar to be attached to a bit at a point where the distance between drill bit tip and collar is equal to planned hole depth. Operators advance bits until drill collars contact work surfaces. Marring may occur when rotating collars strike working surfaces, and wood splintering may occur around holes.

In a first collar type, a threaded hole extends radially inward through the collar wall toward the bit center. Collars become rigidly attached to bits when set screws are advanced in threaded holes until they strongly contact the lands of the bits. A different collar is required for each bit diameter, and users must be careful to avoid damaging the drill bit flutes when tightening the set screw against the bit.

In a second collar type, an extension is formed on each free end of a C-shaped collar. One extension has a threaded hole through it and the other extension has a smooth circular hole (no thread). A set screw passes through the smooth hole into the threaded hole in the opposing extension. Collars are placed on bits at proper points, then screws are turned until collars grip bits fixing them in place.

A third collar type consists of two short cylinders joined by a coiled spring as disclosed in U.S. Pat. No. 4,138,200A. A first cylinder is fixed to the drill bit using a set screw (first collar type) while a second floating cylinder is attached to the first cylinder via a coiled spring. The spring compresses when the floating cylinder strikes the working surface, but the floating cylinder stops rotating thus preventing marring of the working surface. Drilling continues until the spring is fully compressed. Marring is prevented, but this system is complex and is not robust.

A fourth collar type does not lead to marring of work surfaces. For example, U.S. Pat. No. 8,876,444 discloses a collar that includes springs that allow the bottom part of the sleeve to stop rotating when that piece meets the working surfaces. In another type, two cylinders are connected by two races and a set of ball bearings. One cylinder is attached to the bit (first collar type) while the second rotates with the first cylinder until contact is made with the working surface. Marring is largely prevented, and depth of drilling is limited. However, this system is costly, complex, and requires a new device for each drill bit size.

None of these devices keep drill bits aligned perpendicular to work surfaces or work with drilling tools having shanks that are smaller than their bits. The more expensive collars prevent marring, but the inexpensive collars due mar.

Prior art also includes cylinders that fit tightly over drill bit flutes. U.S. Pat. No. 5,078,552 discloses a cylinder that fits over drill bits that are inserted partway into drill chucks positions that set the correct depth of penetration when a cylinder strikes the work surface. Slippage of shanks within chucks will often occur with heavy drilling unless drill bits are fully inserted into drill chucks. These cylinders do not enable the drilling of holes at precise angles relative to work surfaces and do not align bits perpendicular to working surfaces. Marring of working surfaces and splintering of wood may occur.

Prior art also includes a tool that consists of a square, clear plastic plate and a cylinder mounted at its center. Numerous steel cylinders (bushings) resembling sockets having the same outside diameter but differing inside diameters are included with the tool. A single bushing is inserted into the plastic cylinder creating a drill guide. This tool reduces splintering and does not mar working surfaces but does not include a method of controlling depth of drilling. Only bits having a constant diameter can be used with this tool.

Prior art also includes placement of tape around twist and auger bits, and insertion of wires into drill chucks. The tape tends to deform when it meets the work surface changing the depth of penetration. Wires tend to mar work surfaces. None of these systems support precise drill alignment or drilling tools having shanks that are smaller than their bits.

U.S. Pat. No. 3,100,408A provides what is termed a portable drill press. This patent discloses a depth stop and guide device that includes a ring base, two long rods, and a bracket that engages the two rods and supports a second drill chuck. A depth stop is fixed to one rod at an appropriate point. Advancement of the drill bit stops when the bracket strikes the depth stop. The rods can be aligned perpendicular to the base or at modest angles. The top of the base includes beveled notches that permit the drilling of holes through the center of small cylindrical objects placed within the tool. This device is very functional but expensive, cumbersome, and does support the drilling of holes through the center of large diameter cylinders. This tool can be used with bits having constant diameters or bits that are larger than their shanks. This tool does not mar working surfaces but does not reduce splintering. The drill is fastened to the tool when in use, cannot be used for other tasks until separated from the tool, and is heavy.

US 24390008A provides what is termed a drill stand. This patent discloses a depth stop and guide device that includes a large diameter circular base ring that bears on working surfaces and a small diameter upper ring supported by members extending upward from the ring. Bushings of various sizes are mounted in the upper ring. The shank of a drilling tool passes through a bushing mounted within the upper disc. This device allows users to drill holes that are aligned perpendicular to working surfaces. If the drilling tool shank is fitted with a depth stop collar, holes can be drilled to prescribed depths. This device is attached to the drill because the bit cannot pass through the bushing. This device cannot be used to properly drill inclined holes even when placed on a beveled shim because the large diameter bits will bear unevenly on working surfaces. This device is commonly used with special Forstner bits having long shanks. If the device is modified to serve drilling tools having bits and shanks of the same size, the required length of tool becomes excessive, and a different bushing is required for each drilling tool diameter.

Many existing dowel jigs like the tool disclosed in U.S. Pat. No. 5,782,006A are termed self-centering because they automatically place the bit at the center of an edge of a first work piece when clamped to that work piece. This functionality allows holes to be drilled in the exact center of an edge of a first work piece. However, these devices cannot be used to drill dowel holes in the broad face of a second work piece that is to be joined to the first work piece thus limiting their usefulness.

In general, sleeves and collars reduce the length of bit available for drilling making it necessary to purchase longer bits and they do not align bits perpendicular to working surfaces unless used in combination with other tools. Such tools cannot be used with drilling tools having bits that are larger than their shanks. Many such tools are designed for just one task.

Many existing depth stop tools can limit hole depth but cannot align drilling tools perpendicular to working surfaces or at various prescribed angles relative to working surfaces. Some tools serve to align bits perpendicular to working surfaces but cannot limit hole depth unless used in combination with other tools. Many existing depth stop tools rotate when they contact working surfaces marring them. Most depth stop tools do not reduce splintering of wood. Most depth stop tools only support the use of tools that have bits and shanks of the same diameter. One drilling tool maintains the tool perpendicular to flat working surfaces and limits hole depth, but only supports tools that have bits larger in diameter than their shanks (one shank size). Additionally, it is necessary to remove the drilling tool from the depth stop and alignment tool to change bits. This device also requires long drilling tools.

### BRIEF SUMMARY OF THE INVENTION

Embodiments of the present invention include a drill guide that facilitates drilling, tapping, auguring, and similar functions. This invention allows users to drill holes to prescribed depths perpendicular to flat working surfaces with no marring and reduced splintering of wood using hand-held electric drills. This invention allows users to drill holes to precise depths and at variable angles into flat work surfaces and both large and small cylinders using various kinds and sizes of drilling tools including twist, spade, auger, Forstner, and brad-point bits as well as countersinks, unibits, and taps. This invention can be placed on cylinders whereas other inventions require that cylinders be placed within them for drilling. This invention thus allows the drilling of holes at various angles of inclination through the center of both large and small diameter cylinders and cylinders having no free end. This invention allows users to drill dowel holes on edges and faces of workpieces that are spaced apart by various gauged distances and aligned at precise distances from work piece edges.

Drill presses allow users to drill holes to precise depths and alignments in work pieces small enough to fit within them. This invention allows users to drill holes to precise depths and alignments in work pieces that are too large for drill presses and can thus be used in the field and shops.

This invention does not require tools for adjustment and does not need to be fully disassembled for adjustment; thus, individual parts should never be lost. This invention supports the use of multiple drill tool diameters and types without changing components of this invention.

### Drill Guide

The drill guide with no attachments allows users to align holes perpendicular to flat working surfaces and to drill to precise depths with no marring and reduced splintering of wood. The drill guide supports the use of drilling tools having bits that are the same diameter as their shanks including twist, auger, and brad point bits. Multiple bit diameters can be used in the drill guide.

Holes can be drilled to precise depths perpendicular to work surfaces even if the drill guide must be held in an awkward position. For example, holes can be drilled into one side of a wooden post while standing on the opposite side.

### Canting Base Attachment

The drill guide includes a centering and alignment system that properly aligns itself with its attachments. The canting base attachment includes an alignment system that conforms to the alignment system formed in the drill guide.

The drill guide, when mounted on a canting base attachment, supports the use of drilling tools having bits that are the same size as their shanks as well as drilling tools having bits that are larger in diameter than their shanks including Forstner and spade bits, countersinks and unibits. Drilling depth is precisely controlled; thus, countersink holes are properly formed, and unibits repeatedly form correctly sized holes in thin metal sheets. The canting base permits users to drill holes through the center of large and small diameter cylinders and cylinders having no free end. Holes can be drilled to precise depths that are inclined at variable angles relative to flat or cylindrical work surfaces using many kinds of bits. Canting angles can be accurately set and marring of work surfaces is prevented.

The canting base includes gauge structures that permit operators to place it on the work piece so that the drill bit passes through the marked hole location even when the marked location is not visible when drilling. This invention supports both common drilling tasks and the drilling of holes where operators are in awkward positions.

### Dowel Jig Attachment

The dowel jig attachment to the drill guide enables users to drill multiple dowel holes to prescribed depths in the edges and faces of workpieces that are evenly spaced apart and accurately aligned at one setup location. Self-centering dowel jigs can only be used correctly on uniformly thick edges of workpieces having zero or two veneered or finished faces. If workpieces have only one finished or veneered face, then holes should be located at work pieces' structural centers, not their geometric centers. It is often desirable to locate dowel holes closer to one face than another to increase joint strength. Self-centering dowel jigs cannot be used on the broad faces of workpieces.

Like other dowel jigs, this dowel jig must be properly positioned on an edge or face of a work piece at a first location. This dowel jig attachment is termed self-aligning rather than self-centering because the dowel jig can be automatically and correctly positioned at a second location on an edge or face by simply placing it against the work piece using a previously drilled hole and the work piece edge as guides. This dowel jig does not force users to place dowels at the geometric center of an edge. Good joinery requires that the face-to-dowel hole distance be constant and does not require that dowel holes be placed at the geometric center of work pieces. Consider a shelf supported by dowels. For reason of increased strength, dowel holes will desirably be located below the shelf's geometric center. With this self-aligning dowel jig, dowel holes can be accurately located at any location including geometric and structural centers.

With the dowel jig brace removed, the dowel jig attachment can be placed at any location on faces of work pieces. Dowel holes for shelving can be installed that do not fully penetrate the work piece because holes will be drilled to prescribed depths. The dowel jig attachment will be secured to a standard fastened to the work piece.

### OBJECTS OF THE INVENTION

It is an object of the present invention to allow users to drill holes to prescribed depths that are aligned normal to work surfaces without marring and with reduced splintering of wood using drilling tools of multiple sizes that have bits and shanks of the same size.

It is a further object of this invention to allow users to drill holes to prescribed depths that are aligned normal to work surfaces using drilling tools having bits that are the same size or larger than their shanks without marring of the working surface.

Some depth stop tools can be used to drill through the center of small cylindrical objects placed in them but cannot be used on large diameter pipes or on installed pipes having no free ends. It is an object of this invention to allow users to drill holes to prescribed depths through the center of large and small cylindrical objects in both shops and fields, and at variable inclinations, even if they have no free ends.

No existing depth stop tools that attach to twist bits can be used with drilling tools having bits larger in diameter than their shanks. Many existing depth stop tools are secured to bits using a set screw that can be easily lost and which requires a tool for operation. Set screws must bear on the lands of bits to work properly and to avoid damaging drill tools. Other depth stop tools are disposable, lack precision, or deform during use changing depth control. Another kind of collar fits several sizes of bits, but has an appreciable length reducing the maximum depth of drilling for a given bit length.

It is an object of this invention to allow users to align drilled holes perpendicular to work surfaces and to control the depth of drilling when using drilling tools having bits that are larger than their shanks and to eliminate the need for supplemental tools and fasteners.

Self-centering dowel jigs cannot be used to drill dowel holes in the faces of flat work pieces. In addition, self-centering is not desired when work pieces have only one finished or veneered face, or when drilling dowel holes for mitered joints. It is therefore an object of this invention to permit users to drill evenly spaced-apart holes to specific depths into edges of work pieces that are located at constant distances from edges.

It is a further object of this invention to allow users to drill evenly spaced-apart dowel holes in the faces of work pieces.

It is an object of this invention to allow users to drill dowel holes for multiple bit diameters and variable spacings including standard spacings.

It is an object of this invention to allow the creation of both blind and through mitered joints.

### SUMMARY OF ADDITIONAL EMBODIMENTS

Three new drill guide and depth-stop tools named Multiguide, Triguide, and Uniguide (hereinafter drill guides) stem from the original drill guide invention described above. These new drill guides, without attachments, allow users to drill holes to precise depths perpendicular to flat working surfaces and alleviate certain deficiencies of the original drill guide invention that became evident to the inventor after filing of the parent application.

Another embodiment is a new canting base attachment to the new drill guides that allows users to drill inclined holes to precise depths into flat working surfaces and through the center of cylinders on which the canting base is placed. Unlike the canting base attachment disclosed in the parent application, the new canting base is configured to be bolted to drill guides. Thus, users can hold a new drill guide and new canting base attachment as a unit with one hand while operating a drill with their other hand. Convenience, stability, and safety are increased compared to the original drill guide and original canting base disclosed in the parent application.

A new dowel jig attachment allows users to accurately align drill holes separated laterally by gauged distances through both edges and faces of workpieces. The new dowel jig does not have sliding pin adapters that connect drill guides to a dowel jig which are needed with the original dowel jig. This change eliminates the potential for inadvertent slippage and misplacement of dowel holes.

The new dowel jig body has a front flange projecting from its front face and a rear flange projecting from its rear face whereas the original dowel jig had a flange on only the front face of the dowel jig. Only the front flange is used when drilling dowel holes in edges of workpieces. Both flanges are used when drilling dowel holes into faces of workpieces. The addition of the flange to the rear face of the dowel jig aligns the dowel jig body parallel to the workbench surface and the workpiece and aligns drill bits perpendicular to workpiece faces.

The integral clamping system shown in the parent application was not useful in all cases and has therefore been removed. External clamps engage the dowel jig brace and the workpiece in the case of edge holes, or the dowel jig body and workpiece in the case of face holes. This change increases convenience and reduces the size and complexity of the dowel jig body. Additionally, it provides a means of securely holding the dowel jig body in correct position regardless of workpiece size and shape.

These inventions generally relate to woodworking and joinery, although the inventions can also be used with other crafts and materials.

The parent application includes a brief discussion of other embodiments that would serve as bushing carriers but does not include any drawings or claims related to those embodiments. Triguide and Uniguide disclosed in this continuation-in-part (CIP) application serve as bushing carriers.

Drill presses allow users to drill holes to precise depths and alignments in small workpieces. These three new drill guides allow users to drill holes to precise depths and alignments in workpieces that are too large for drill presses and can thus be used in fields and shops.

Like the original drill guide disclosed in the parent application, Multiguide, Triguide, and Uniguide (drill guides) allow users to:
drill holes to prescribed depths perpendicular to flat working surfaces with no marring and reduced wood tear out using hand-held electric drills;
drill holes to precise depths and at variable angles into flat work surfaces and both large and small cylinders using various kinds and sizes of drilling tools including twist, spade, auger, Forstner, and brad-point bits as well as countersinks, unibits, and taps;
place these tools on cylinders whereas prior art requires users to place cylinders within tools;
drill holes at various angles of inclination through the center of both large and small diameter cylinders and cylinders having no free end; and
drill dowel holes on edges and faces of workpieces that are spaced apart by various gauged distances and aligned at precise distances from workpiece edges.

### Multiguide

Multiguide is most useful when 1) drilling just a few holes to one precise depth that are aligned perpendicular to flat working surfaces, and 2) in spur-of-the-moment situations because it is quick to set up for depth and includes many bushing sizes.

Multiguide allows users to drill holes of just one size to one maximum depth that aligned perpendicular to flat working surfaces. Rotating drill chucks meet Multiguide, not working surfaces, when maximum hole depth is reached avoiding any marring. Multiguide bears on working surfaces around bits reducing wood tear out. Multiguide allows user to drill through holes of various sizes at just one setting that are aligned perpendicular to flat working surfaces. A first small diameter hole might be drilled as a pilot hole and a larger hole might be drilled at the same spot forming the completed hole.

No tools are required for depth adjustment for Multiguide. Furthermore, setup times for Multiguide are short.

Users can drill holes to prescribed depths that are perpendicular to flat working surfaces using Multiguide and drilling tools such as Forstner bits by holding their shanks against notches in the edges of Multiguide. It is necessary to raise the base of Multiguide to provide space for the bit. This can be done by placing a simple block or the canting base attachment beneath Multiguide.

Multiguide supports both functions (maximum hole depth and perpendicular alignment with working surfaces) without requiring that it be connected to an electric drill. Multiguide excels when just a few holes of just one size must be drilled to some maximum depth, and when multiple through holes of different sizes must be drilled.

### Triguide

Triguide is similar in form to Multiguide and identical to Multiguide in function but has three replaceable bushing carriers (bushing inserts with steel bushing) rather than multiple fixed bushings. Triguide thus has a longer service life than Multiguide.

Users can drill through holes having as many as three different sizes with just one set of three bushing inserts. For example, a user might have two drills, each holding a different bit diameter. With corresponding bushing inserts installed, users can drill pilot holes with one drill and bushing, then drill full-sized holes using a second bit and bushing. Holes will be aligned perpendicular to flat working surfaces. Other embodiments having more or fewer bushings in each plate can readily be developed. Additionally, bushing inserts and bushings can be replaced by full-sized bushings having threaded edges.

### Uniguide

Uniguide differs greatly in appearance and form from the original drill guide, Multiguide, and Triguide in that it has, in its most simple form, just one somewhat cylindrical body that contains top and bottom bushing inserts that limit depth of drilling and align drill bits perpendicular to flat working surfaces. Long drill bits can be used with Uniguide by attaching one or more segments to its top and installing a top bushing insert in the top-most segment rather than the body. Bushings work best with twist bits. Uniguide can also be used with drilling tools having bits that are larger than their shanks such as Forstner bits. Uniguide provides infinitely fine depth control for many drilling tool types. Uniguide can be used in tighter quarters than the original drill guide, Multiguide, and Triguide because it has a smaller footprint. Uniguide is best used when many holes of the same diameter must be drilled.

### Centering and Alignment System

The parent application required that Multiguide have 1) a large centering pin recess at its center that could receive a smooth (i.e., non-threaded) centering pin projecting upward from attachments, and 2) a multiplicity of smaller alignment pin recesses that could receive alignment pins projecting upward from attachments.

The centering and alignment system disclosed in the parent application kept Multiguide centered on canting base attachments and on individual sliding block adapters used with dowel jig attachments, but Multiguide could not be secured to canting base attachments. Additionally, the parent application required that a sliding pin adapter be provided for each sliding block used with dowel jig attachments.

This CIP application discloses a new centering and alignment system that 1) allows drill guides to be secured to canting base attachments and 2) eliminates the need for sliding pin adapters. A shallow threaded hole is formed at the center of the bottom of all three new drill guides that can receive the threaded end of either a connecting bolt (used with a canting base) or a centering pin (used with the dowel jig). Connecting bolts secure drill guides to canting base attachments. Centering pins engage matching recesses in dowel jig sliding blocks.

A multiplicity of shallow threaded alignment pin holes are formed at constant radial distances from the center hole in drill guide bottom faces that can receive threaded alignment pins when used with attachments. The new drill guides disclosed in this CIP application have threaded alignment pin holes in their bases, matching recesses in canting base and dowel jig attachments, and threaded alignment pins.

This new centering and alignment system enables drill guides to be secured to the canting base attachment and eliminates the need for sliding pin adapters that might inadvertently slide on sliding blocks.

### Canting Base Attachment

Canting base attachments to drill guides allow users to drill inclined holes into flat working surfaces. Canting bases align with cylinder centers when placed upon cylinders having zero or more free ends. Holes can then be drilled through cylinder centers that extend to precise depths. The new canting base is secured to drill guides using a connecting bolt. Users thus manipulate both the drill guide and canting base attachment with just one hand while operating a drill with their other hand. This increases stability, convenience, and safety compared to the original canting base attachment. A shaft slidingly connected to the canting base raises the back end of the canting base when secured in a lower position.

### Dowel Jig Attachment

The new dowel jig attachment disclosed in this CIP application differs from that disclosed in the parent application in that the new dowel jig has no sliding pin adapters. A centering pin recess and a multiplicity of alignment pin recesses are formed in the top surfaces of the center and each outboard sliding block. A threaded centering pin and a multiplicity of threaded alignment pins are installed in recesses in drill guide bases. These simple changes eliminate sliding pin adapters, the possibility of inadvertent movements, and misplacement of dowel holes.

The integral clamping system disclosed in the parent application did not work in all cases and conditions. The new dowel jig disclosed in this CIP application does not have an integral clamping system but has more convenient and secure surfaces for exterior clamping devices. The dowel jig brace disclosed in the parent application had two gusset plates. The new dowel jig brace disclosed in this CIP application has only one gusset plate and thus has increased space for placement of external clamps. External clamps can be employed to secure dowel jigs to a wide variety of workpieces and configurations.

Self-centering dowel jigs can only be used correctly on uniformly thick edges of workpieces having two veneered or finished faces. If workpieces have only one finished or veneered face, then holes should be located at their structural centers, not their geometric centers. It is often desirable to locate dowel holes closer to one face than another to increase joint strength.

Good joinery requires that face-to-dowel hole distances be constant and does not require that dowel holes be placed at geometric centers of workpieces. Consider shelfs supported by dowels. For reason of increased strength, dowel holes will desirably be located below a shelf's geometric center. The new dowel jig disclosed in this CIP application does not force users to place dowels at the geometric center of an edge. Dowel holes can be accurately located at any location including geometric and structural centers. The new drill guides and new dowel jig attachment disclosed in this application-in-part application enable users to drill multiple dowel holes to prescribed depths in the edges and faces of workpieces that are evenly spaced apart and accurately aligned at one setup location.

Self-centering dowel jigs cannot be used on broad faces of workpieces. The dowel jigs disclosed in both the parent application and this CIP application can be used to drill dowel holes into edges and broad faces of workpieces of various thicknesses and sizes.

Dowel jigs must be properly positioned on an edge or face of a workpiece at a first location. This new dowel jig attachment can be automatically and correctly positioned at a second location on an edge or face by simply placing it against the workpiece using the last drilled hole and the workpiece edge as guides. The new dowel jig is thus described as being self-aligning rather than self-centering.

The new dowel jig brace disclosed in this CIP application has only one gusset plate and provides three suitable locations for external clamps. The new dowel jig brace can readily be used to drill holes into the narrow ends of long workpieces and is much more convenient and secure than the original dowel jig brace because it provides more suitable places to mount external clamps.

With the dowel jig brace removed, the dowel jig disclosed in the parent application could be placed at any location on faces of workpieces. However, it became evident that the integral clamp could not be used to secure the dowel jig in place on the workpiece. The dowel jig disclosed in this CIP application can readily be clamped in place on the faces of workpieces using external clamps.

The dowel jig disclosed in the parent application lacked a convenient method of aligning the dowel jig with the workpiece so that the drill bits would be aligned perpendicular to the workpiece face. The new dowel jig disclosed in this CIP application includes a flange added to the rear face of the dowel jig body that comes into play when dowel holes are to be drilled into the faces of workpieces. A scrap of material having the same thickness as a workpiece is placed beneath the rear flange and the front flange (alignment edge) is place on and against the end of the workpiece that is to receive dowel holes. The dowel jig is then aligned parallel to the workbench and drill bits will be aligned perpendicular to workpiece faces.

### OBJECTS OF THE ADDITIONAL EMBODIMENTS

The object of the Multiguide, Triguide, Uniguide, new canting base, and new dowel jig inventions disclosed in this CIP application is to improve upon the convenience, stability, and safety provided by the inventions disclosed in the parent application. These improvements come about largely by reversing the positions of pins and matching recesses among the new drill guides and attachments. Though seemingly a trivial change, it leads to great improvements in convenience, stability, and safety when the new drill guides are used in conjunction with the new canting base and dowel jig attachments. In particular, the new canting base can be securely attached to the drill guides and sliding block adapters are not needed with the new dowel jig. The new dowel jig does not have integral clamps but does have a flange on its rear face that facilitates alignment of the dowel jig with workpieces.

Many existing depth-stop tools can limit hole depth but cannot align drilling tools perpendicular to working surfaces or at various prescribed angles relative to working surfaces. Some tools align bits perpendicular to working surfaces but cannot limit hole depth unless used in combination with other tools. Many existing depth-stop tools rotate when they contact working surfaces, which mars the working surfaces. Most depth-stop tools do not reduce wood tear out. Most depth-stop tools only support the use of drilling tools that have bits and shanks of the same diameter. One drilling tool maintains drilling tools perpendicular to flat working surfaces and limits hole depth, but only supports tools that have bits larger in diameter than their shanks (one shank size). Additionally, it is necessary to remove the drilling tool from the depth-stop and alignment tool to change bits. This device also requires long drilling tools.

It is therefore an object of the present invention to allow users to drill holes to prescribed depths that are aligned normal to work surfaces without marring and with reduced wood tear out using drilling tools having bits that are the same size or larger than their shanks.

Some depth-stop tools can be used to drill through the center of small cylindrical objects placed in them but cannot be used on large diameter pipes or on installed pipes having no free ends. It is an object of this invention to allow users to drill holes to prescribed depths through the center of large and small cylindrical objects in both shops and fields, and at variable inclinations, even if the cylindrical objects have no free ends. A further object of these inventions is to provide a tool assembly that can be controlled with just one hand.

No existing depth-stop tools that attach to twist bits can be used with drilling tools having bits larger in diameter than their shanks. Many existing depth-stop tools are formed as a collar that is secured to bits using a set screw that can be easily lost and which requires a tool for operation. Set screws must bear on the lands of bits to work properly and to avoid damaging drill tools. Another kind of collar fits several sizes of bits, but has an appreciable length reducing the maximum depth of drilling for a given bit length and increasing the required length of drilling tools. Other depth-stop tools are disposable, lack precision, or deform during use changing depth control.

It is an object of this invention to allow users to align drilled holes perpendicular to work surfaces and to control the depth of drilling when using drilling tools having bits that are larger than their shanks and to eliminate the need for supplemental tools and fasteners.

Self-centering dowel jigs cannot be used to drill dowel holes in the faces of flat workpieces. In addition, self-centering is not desired when workpieces have only one finished or veneered face, or when drilling dowel holes for miter joints. It is therefore an object of this invention to permit users to drill evenly spaced-apart holes to specific depths into edges of workpieces that are located at constant distances from workpiece edges.

It is a further object of this invention to allow users to drill evenly spaced-apart dowel holes in the faces of workpieces.

It is an object of this invention to allow users to drill dowel holes for multiple bit diameters and variable spacings including standard spacings.

It is an object of this invention to allow the creation of both blind and through miter joints.

It is an object of this invention to allow users to secure Multiguide, Triguide, or Uniguide to the canting base attachment so that they become a unit that users can control with one hand while operating a drill with their other hand.

It is a further object of this invention to eliminate the need for users to swap out pin adapters for blank adapters while drilling dowel holes.

It is a further object of this invention to provide a dowel jig brace that allows users to more conveniently and safely clamp the dowel jig to narrow workpieces.

It is a further object of this invention to provide a means of aligning dowel jigs with workpieces so that drill bits will be aligned perpendicular to workpiece faces.

### BRIEF DESCRIPTION OF THE FIGURES

Cheese Embodiments of the present invention are described in detail below with reference to the attached drawing figures, wherein:

FIG. 1 is a perspective exploded view of a drill guide constructed in accordance with an embodiment of the invention;

FIG. 2 is a perspective view of a bottom plate of the drill guide of FIG. 1;

FIG. 3 is a bottom perspective view of the bottom plate of FIG. 2;

FIG. 4 is a perspective view of a top plate of the drill guide of FIG. 1;

FIG. 5 is a bottom perspective view of the top plate of FIG. 4;

FIG. 6 is a perspective view of a double nut of the drill guide of FIG. 1;

FIG. 7 is a cutaway perspective view of the double nut of FIG. 6;

FIG. 8 is a perspective view of the drill guide of FIG. 1;

FIG. 9 is a plan view of a canting base attachment constructed in accordance with another embodiment of the invention;

FIG. 10 is a perspective view of the canting base attachment of FIG. 9;

FIG. 11 is a bottom perspective view of the canting base attachment of FIG. 9;

FIG. 12 is a perspective view of the drill guide of FIG. 1 and the canting base attachment of FIG. 9;

FIG. 13 is a perspective view of a dowel jig body of a dowel jig attachment constructed in accordance with another embodiment of the invention;

FIG. 14 is a bottom view of the dowel jig body of FIG. 13;

FIG. 15 is a dowel jig brace of the dowel jig attachment;

FIG. 16 is a perspective view of a center sliding block of the dowel jig attachment;

FIG. 17 is a bottom perspective view of the center sliding block of FIG. 16;

FIG. 18 is a cutaway plan view of the center sliding block of FIG. 16;

FIG. 19 is a perspective view of an outboard sliding block of the dowel jig attachment;

FIG. 20 is a bottom perspective view of the outboard sliding block of FIG. 19;

FIG. 21 is a perspective view of a pin adapter of the dowel jig attachment;

FIG. 22 is a bottom perspective view of the pin adapter of FIG. 21;

FIG. 23 is a perspective view of a blank adapter of the dowel jig attachment;

FIG. 24 is a bottom perspective view of the blank adapter of FIG. 23;

FIG. 25 is a perspective view of the dowel jig attachment;

FIG. 26 is an exploded view of the drill guide of FIG. 1 and the dowel jig attachment of FIG. 25;

FIG. 27 is a perspective exploded view of a drill guide (Multiguide) constructed in accordance with an embodiment of the invention;

FIG. 28 is a perspective view of the drill guide of FIG. 27;

FIG. 29 is a bottom perspective view of the drill guide of FIG. 27;

FIG. 30 is a bottom perspective exploded view of a drill guide (Triguide) constructed in accordance with another embodiment of the invention;

FIG. 31 is a perspective view of the drill guide of FIG. 30;

FIG. 32 is a bottom perspective view of the drill guide of FIG. 30;

FIG. 33 is a perspective exploded view of a drill guide (Uniguide) constructed in accordance with another embodiment of the invention;

FIG. 34 is a perspective view of the drill guide of FIG. 33;

FIG. 35 is a bottom perspective view of the drill guide of FIG. 33;

FIG. 36 is another perspective view of the drill guide of FIG. 33;

FIG. 37 is another perspective view of the drill guide of FIG. 33;

FIG. 38 is a perspective view of a canting base attachment constructed in accordance with another embodiment of the invention;

FIG. 39 is a bottom perspective view of the canting base attachment of FIG. 38;

FIG. 40 is a perspective view of a dowel jig attachment constructed in accordance with another embodiment of the invention;

FIG. 41 is a bottom perspective view of the dowel jig attachment of FIG. 40;

FIG. 42 is a perspective view of a center sliding block of the dowel jig attachment of FIG. 40;

FIG. 43 is a bottom perspective view of the center sliding block of FIG. 42;

FIG. 44 is a perspective view of the center sliding block of FIG. 42;

FIG. 45 is a bottom perspective view of an outboard sliding block of the dowel jig attachment of FIG. 40;

FIG. 46 is a perspective view of a dowel jig brace of the dowel jig attachment of FIG. 40; and

FIG. 47 is a bottom perspective view of the dowel jig brace of FIG. 46.

### DETAILED DESCRIPTION

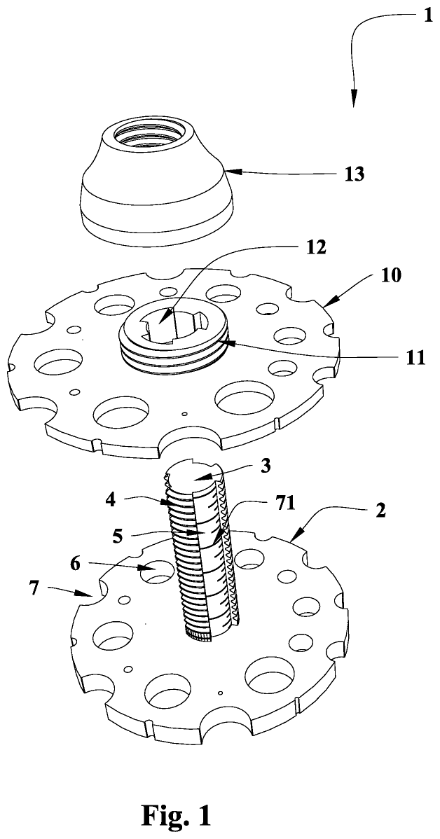

FIG. 1 shows the three primary components of the drill guide 1 in an exploded view: bottom plate 2, top plate 10, and double nut 13. The bottom plate has a threaded shaft 3 attached to its center, threads 4 interrupted by alignment grooves 5, multiple fully circular holes 6, multiple semi-circular edge notches 7, and depth graduations 71. The circular holes are located on a circle having a radius termed the Alignment Radius.

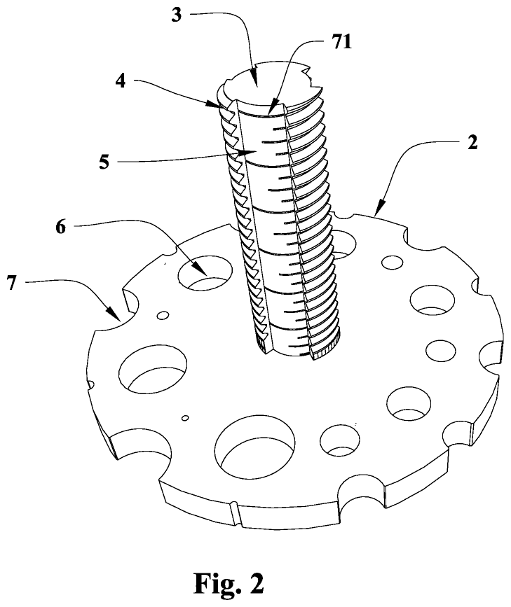

FIG. 2 shows a top-isometric view of the bottom plate 2 and rigidly attached shaft 3 having threads 4 interrupted by alignment grooves 5. Depth graduations 71 are formed in one or more alignment grooves. Fully circular holes 6 and semi-circular notches 7 are arranged around the shaft in a favorable order. In this preferred embodiment, 12 circular holes are paired with 12 semi-circular notches, so the constant angular separation between hole centers is 30°. The largest fully circular hole is paired with the smallest notch on the same radial line. The second largest hole is paired with the second smallest notch on the adjacent radial line. This pattern is repeated around the perimeter of the bottom plate. Other arrangements are possible.

Multiple alignment grooves provide stability, proper alignment of top and bottom plates is maintained by making one alignment groove wider or narrower than all others.

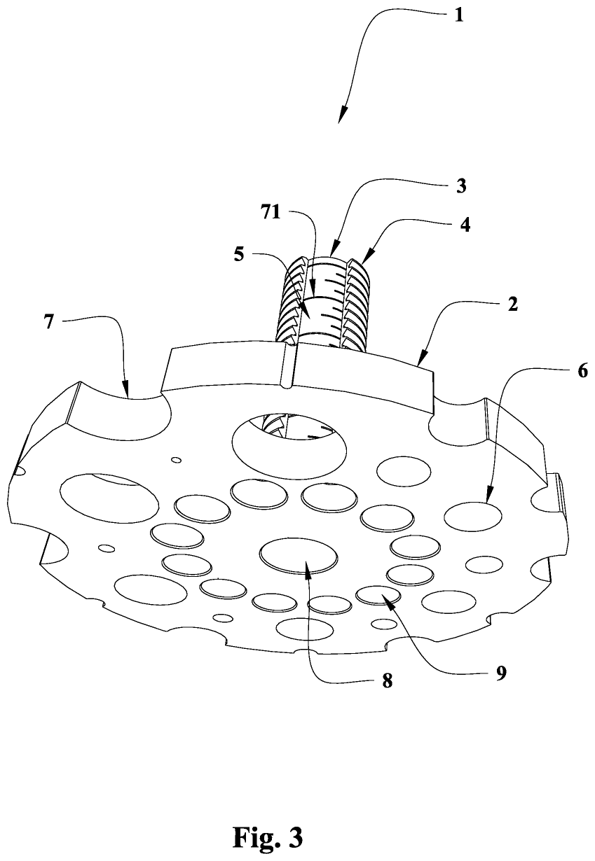

FIG. 3 shows the bottom surface of the bottom plate 1. A center alignment recess 8 is located at the center of the bottom plate and numerous alignment pin recesses 9 are centered about it in a circle termed the Alignment Circle. The radius of the Alignment Circle is termed the Alignment Radius. These recesses form an alignment system that is aligned with the holes 6 and notches 7 in the plates. The shaft 3, threads 4, alignment grooves 5, and depth graduations 71 are also visible in this figure.

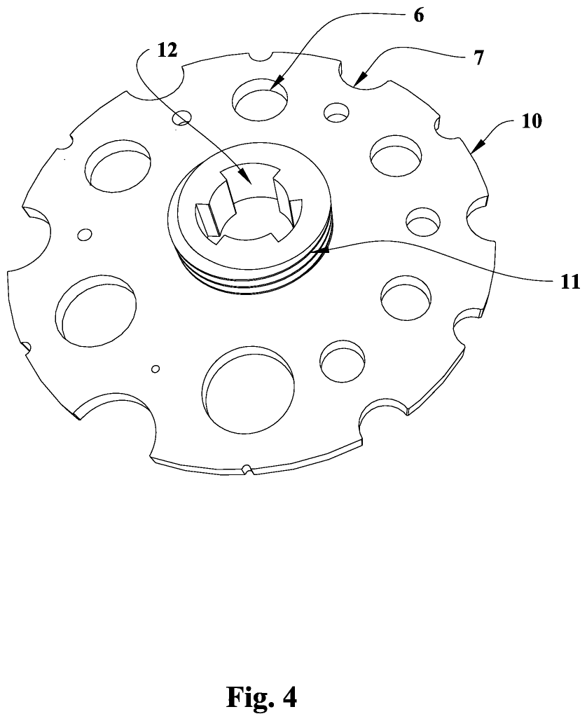

FIG. 4 shows a top view of the top plate 10 and integral threaded collar 11. Fully circular holes 6 and semi-circular notches 7 matching those formed in the bottom plate in both size and arrangement are formed in the top plate. A threaded collar 11 and non-circular hole 12 are located at the center of the top plate 10. The non-circular hole conforms to the cross-sectional shape and size of the shaft attached to the bottom plate.

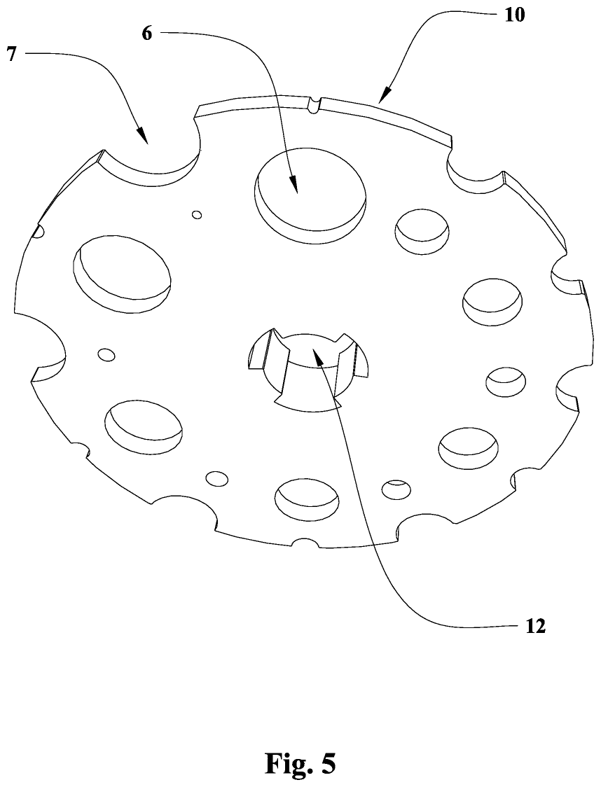

FIG. 5 shows a bottom view of the top plate 10. No new features appear in FIG. 5.

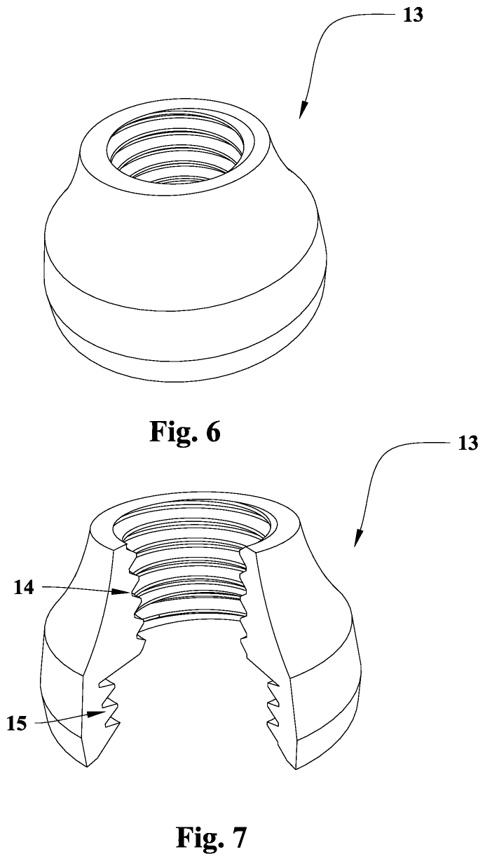

FIG. 6 shows an isometric view of the double nut 13.

FIG. 7 shows a cut-away view of the double nut with double-nut shaft threads 14 and double-nut collar threads 15 inside the double nut. The larger diameter collar threads at the bottom of the double nut engage the threaded collar on the top plate, and the smaller diameter shaft threads at the top of the double nut 14 engage the shaft threads on the bottom plate.

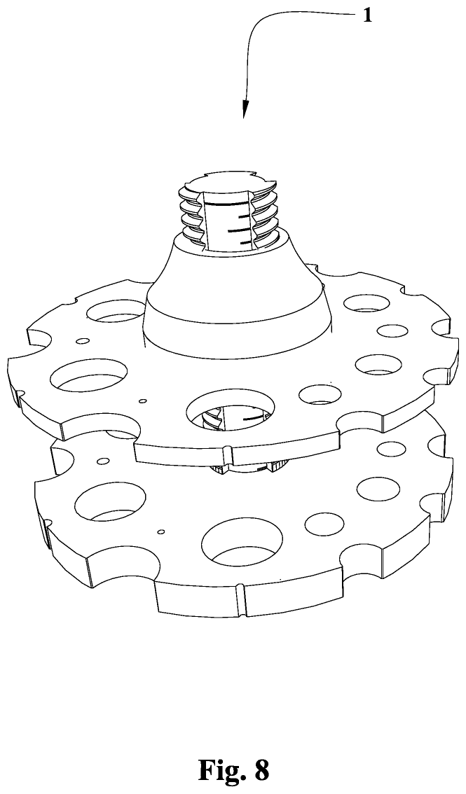

FIG. 8 shows the drill guide 1 as assembled.

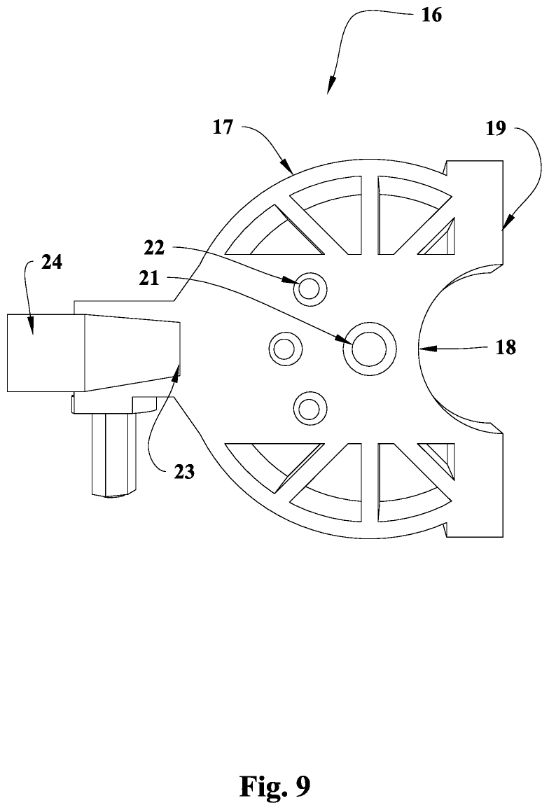

FIG. 9 shows a top view of the canting base attachment 16 that can be placed below a drill guide enabling the use of drilling tools having bits that are larger in diameter than their shanks and the drilling of holes through cylinder centers. The canting base block 17 is roughly circular in shape, has the same diameter as the top and bottom plates, and has an appreciable thickness. A large diameter drill bit recess hole 18 is formed on the periphery of the canting base block. A secant cut made through the center of the drill bit recess hole marks the front of the block and forms two front faces 19 that can have a width equal to the Hole Radius.

A center alignment pin 21 is located at the center of the top surface of the canting base block along with three alignment pins 22 that are offset from the centering pin by the Alignment Radius. A canting shaft 24 slides up and down within a canting shaft hole 23 in the canting base attachment.

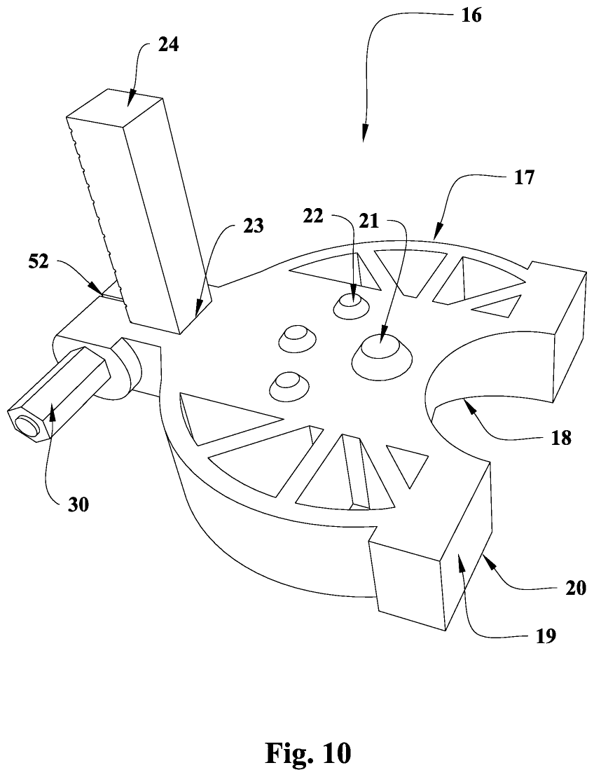

FIG. 10 shows a top-front isometric view of the canting base attachment 16 having two upright, rectangular, front faces 19. The bottom edges of the two front faces form pivot edges 20. The canting shaft 24 can move up and down within the canting shaft hole 23 and can be fixed in place by rotating the clamping rod with knob 30 to close the gap 52 in the projection at the rear of the canting base attachment. Lowering the canting shaft causes the canting base to pivot around the pivot edges 20 when the attachment is placed upon a flat surface. A center alignment pin 21 and two alignment pins 22 are formed on the top of the canting base block 17.

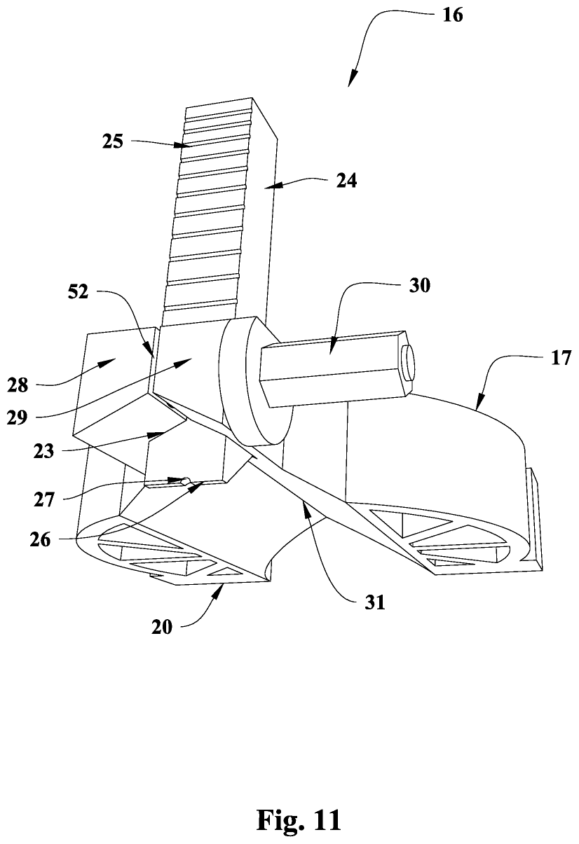

FIG. 11 shows a bottom-rear isometric view of the canting base attachment 16. A V-shaped groove 31 is formed in the bottom surface of the canting base attachment. This groove forces the canting base attachment to align itself with cylinders when placed upon them. A left projection 28 and right projection 29 extend rearward from the rear of the canting base block 17. The left and right projections are separated by a gap 5 and a canting shaft hole 23. A knob is fastened to a threaded rod forming the clamping rod with knob 30. The threaded rod passes through a smooth hole in the right projection (not visible in this view), the open gap, and through a threaded hole in the left projection 28 (also not visible in this view). Users may close the gap and clamp the canting shaft in place by rotating the clamping rod with knob 30 until the gap 52 is nearly closed. A straight canting shaft edge 26 is formed at the bottom end of the canting shaft 24. A center alignment notch 27 is formed at the center of the canting edge that is in alignment with the V-shaped groove 31.

If the canting shaft is moved downward so that the canting shaft edge is lower than the canting base, then the canting base will be rotated about the pivot edge 20 when placed on a flat working surface. Drill bit alignment will then be canted relative to flat or cylindrical work surfaces.

Angle graduations 25 can be formed on one or more surfaces of the canting shaft allowing users to set the proper canting angle without measuring when working with flat working surfaces.

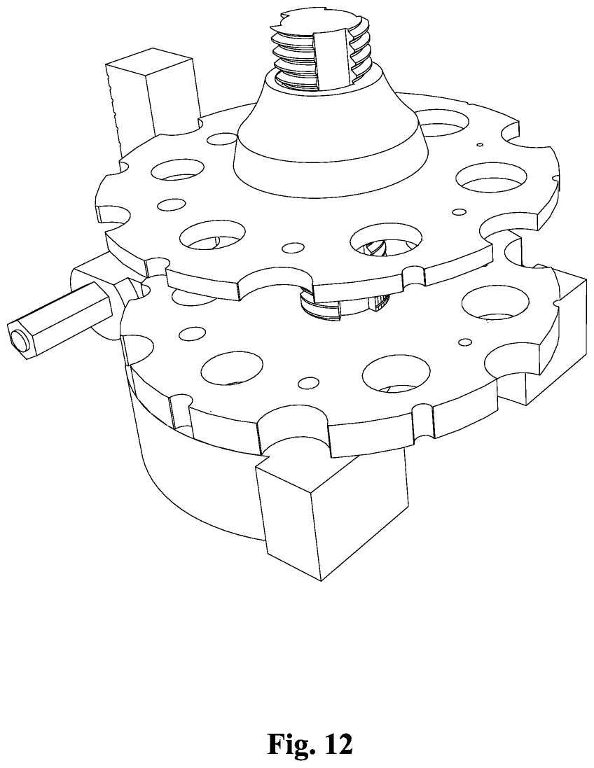

FIG. 12 shows the drill guide in position on the canting base attachment.

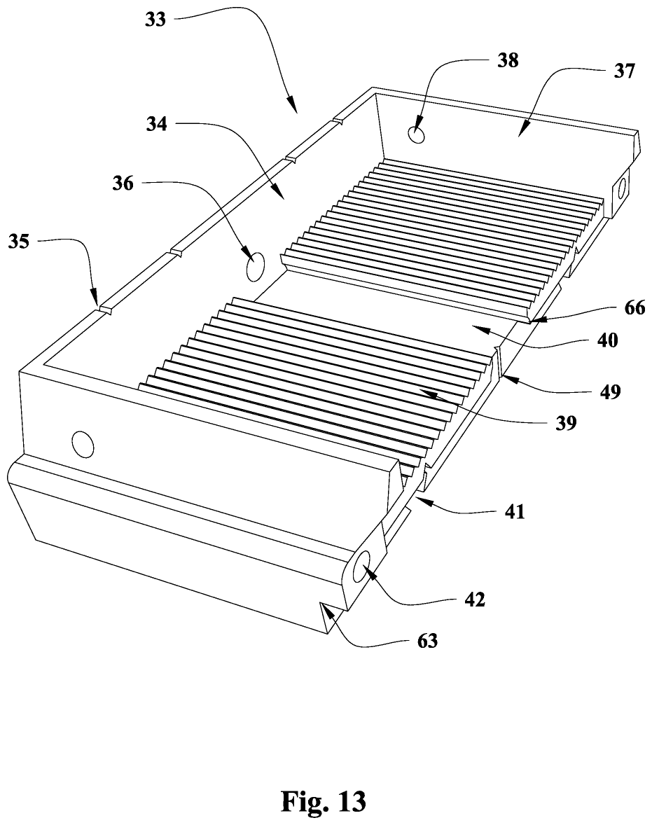

FIG. 13 shows a top-front isometric view of the dowel jig body 33 that includes two grooved pans 39 and a center guide slot 40. Guide slot grooves 66 are formed on each side of the center guide slot. Two side walls 37 and a back wall 34 rise above the grooved pans 39. A control rod hole 36 is formed in the back wall, and an alignment rod insertion hole 38 is formed in each side wall. A smooth clamp rod hole 42 is formed in each side wall that extends from the front to back faces of the dowel jig body. A ledge 63 is formed on the front face of the dowel jig body. A centerline groove 49 is formed at the center of the front face of the dowel jig body. Jig spacing index notches 35 are formed on the top surfaces of the back wall that correspond to a standard dowel hole spacing interval. Brace fixture slots 41 are formed in the bottom face of the dowel jig body.

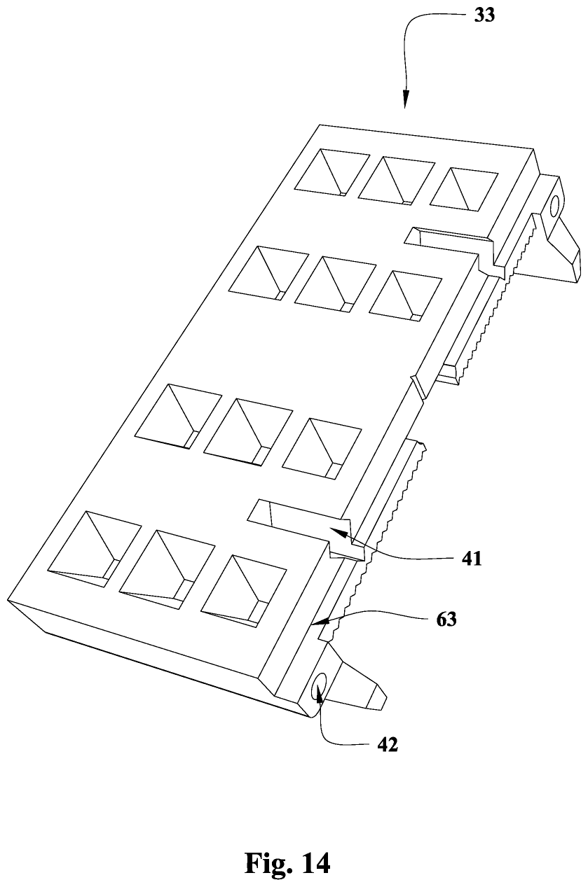

FIG. 14 shows a bottom-front isometric view of a dowel jig body 33. Multiple brace fixture slots 41 are formed in the bottom face of the dowel jig body. A smooth clamp rod hole 42 extends from back to front through the dowel jig attachment. The dowel jig is properly positioned on a work piece when its ledge 63 rests on an edge of that work piece.

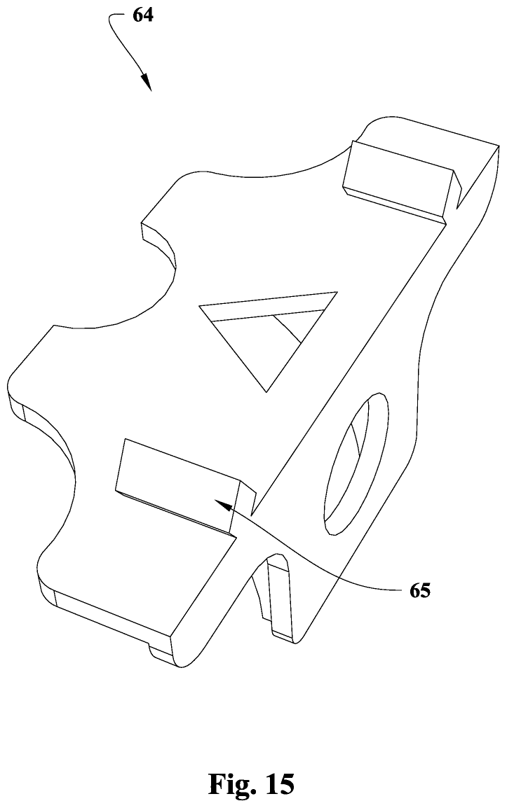

FIG. 15 shows a dowel jig brace 64 with brace fixtures 65 that slide within the brace fixture slots 41 shown in FIG. 14.

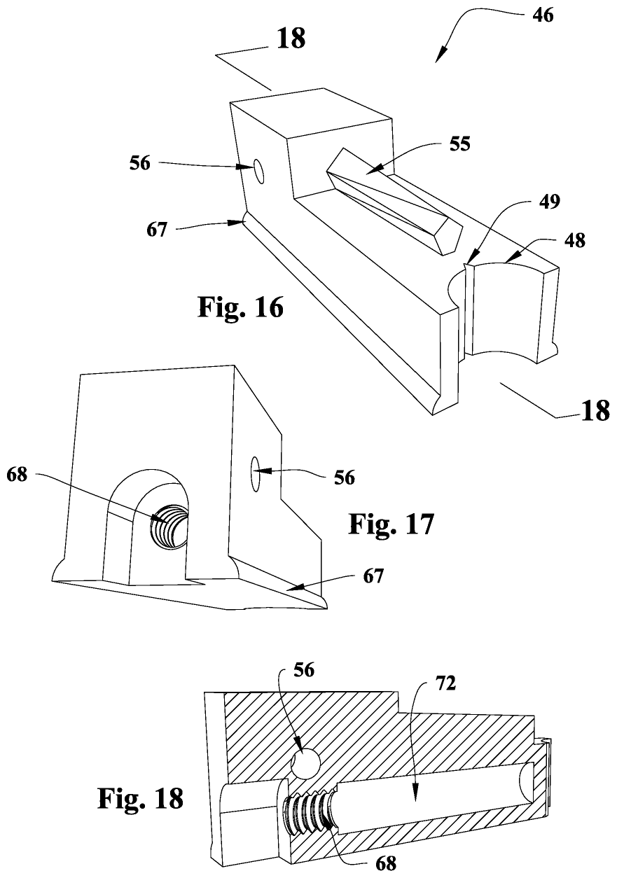

FIG. 16 shows a top isometric view of a center sliding block 46 with an adapter flange 55 projecting from its top surface. An alignment rod hole 56 extends laterally through the center sliding block. A guide slot projection 67 is formed at the bottom of long edges of the center sliding block.

FIG. 17 shows a bottom-rear isometric view of the center sliding block with a short threaded hole 68. The alignment rod hole 56 and guide slot projections 67 are visible in this figure.

FIG. 18 shows a cut-away view of the center sliding block cut at its center. A short, threaded hole 68 and an open hole (control rod operating space 72) are visible in this view.

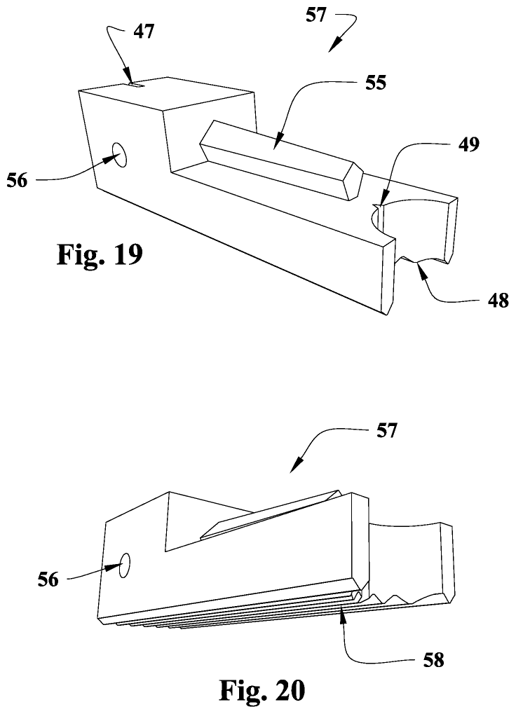

FIG. 19 shows a top-front isometric view of an outboard sliding block 57. A flange adapter 55 projects from its top surface, and an alignment rod hole 56 extends laterally through the rear of the outboard sliding block. An adapter center notch 47 and a centerline groove 49 mark the center of the outboard sliding block. A semi-circular dowel recess hole 48 is formed in the front face of the outboard sliding block.

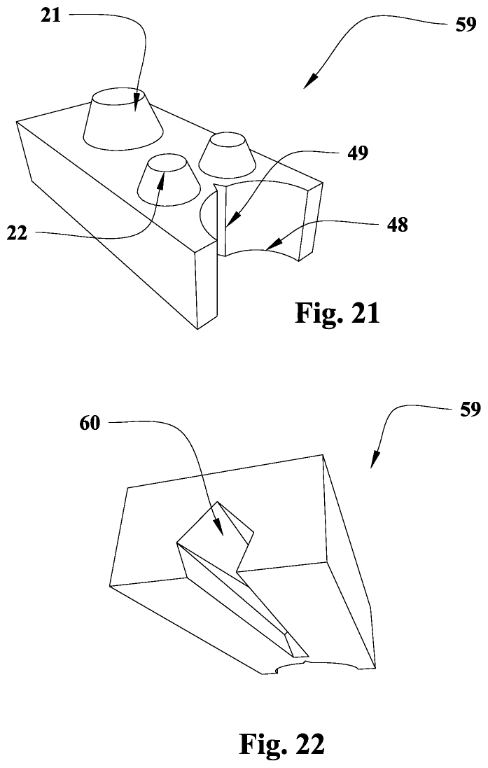

FIG. 20 shows a bottom-front isometric view of an outboard sliding block 57 which has a grooved bottom face and an alignment rod hole 56.

FIG. 21 shows a top-front isometric view of a pin adapter 59. A center index pin 21 and two alignment pins 22 extend upward from the top surface of the adapter. A dowel recess hole 48 is formed in the front of the adapter, and a centerline groove 49 marks the center of the pin adapter.

FIG. 22 shows a bottom-rear view of a pin adapter 59 and an adapter flange slot 60.

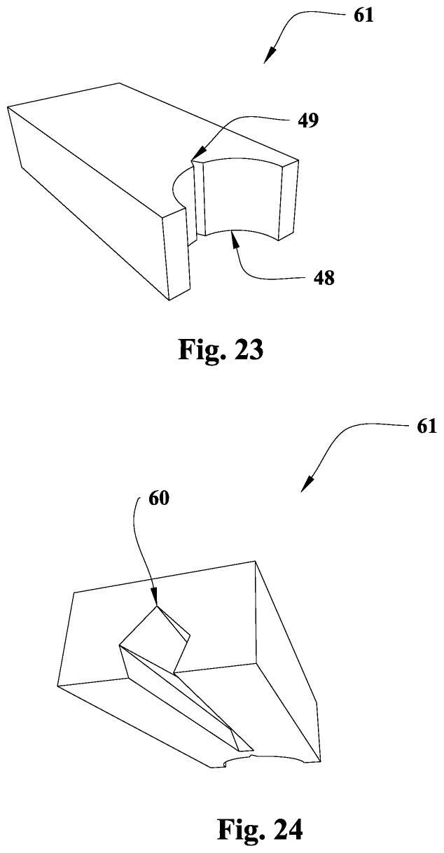

FIG. 23 shows a front-top view of blank adapter 61. The top surface of the blank adapter has no alignment pins, but blank adapters do have a dowel recess hole 48 and a center line groove 49.

FIG. 24 shows a bottom-rear isometric view of a blank adapter 61. An adapter flange slot 60 is formed in the base of the blank adapter that extends from the rear to near its front.

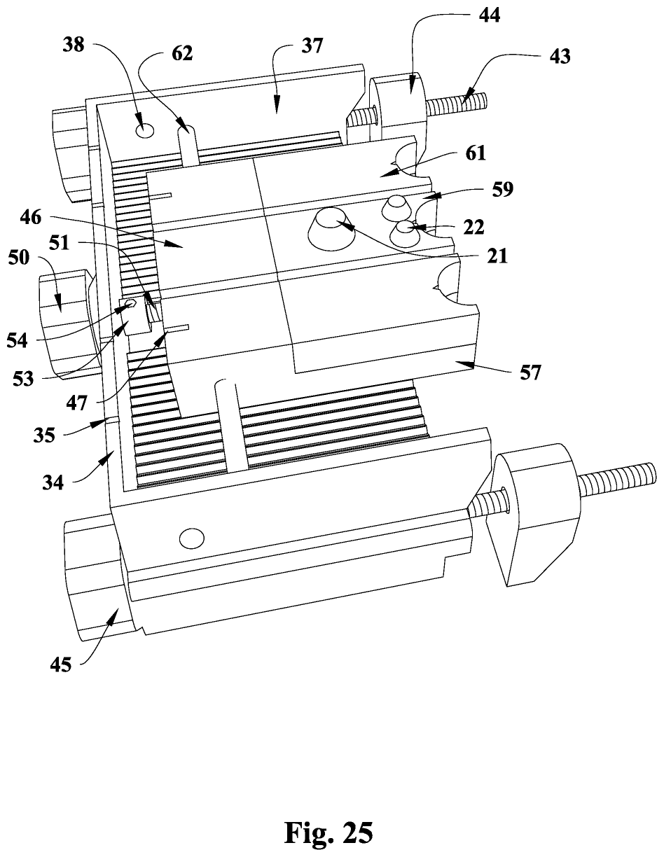

FIG. 25 shows the moveable components of the dowel jig attachment in position in the dowel jig body. The clamp rod knob 45 is attached to a threaded clamp rod 43. A clamp bracket is threaded onto each threaded clamp rod. A control rod knob 50 is rigidly connected to a threaded control rod 51 that passes through the back wall 34 of the dowel jig body. A control rod collar 53 is fixed to the threaded control rod via a set screw 54. The threaded control rod extends into the central sliding block 46, through the short length of threaded hole, and into the control rod operating space. A smooth alignment rod 62 passes laterally through the rear portion of the central sliding block 46 and all outboard sliding blocks 57. One pin adapter 59 is shown in position on a center sliding block 46. A blank pin adapter 61 is shown on each outboard sliding block 57. All sliding blocks, the pin adapter, all blank adapters, and the alignment rod move when the control rod knob is rotated.

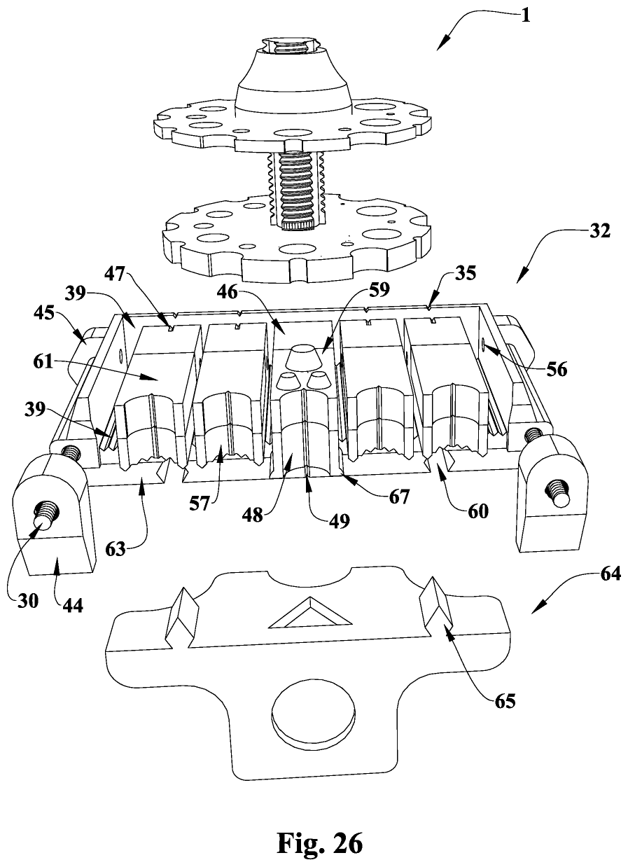

FIG. 26 shows a top-front isometric, expanded view of the drill guide 1, the dowel jig attachment 32, and the dowel jig brace 64. When fully assembled, the drill guide rests on the dowel jig attachment with its alignment recesses engaged with the alignment pins on the pin adapter. Likewise, the brace fixtures on the dowel jig brace slide into the brace fixture slots 41 locking the brace to the dowel jig attachment. A center sliding block 46 and pin adapter 59 are located at the center of the dowel jig, and multiple outboard sliding blocks 57 with multiple blank adapters 61 are positioned on either side of the center sliding block in this arrangement. The single pin adapter can be interchanged with any one of the blank adapters creating multiple arrangements. The dowel jig is placed on an edge of a work piece with its ledge 63 bearing on the edge of the work piece.

Standard dowel jig spacing is produced when adapter center notches 47 and outboard sliding blocks 57 align with jig spacing index notches 35 formed in the rear wall of the dowel jig body.

### Description of Operation

### Drill Guide

In this preferred embodiment, the drill guide is comprised of a bottom plate, top plate, and double nut as shown in FIG. 1. The bottom plate has a threaded shaft attached to the center of its top surface. Three alignment grooves interrupt threads on the shaft. The top plate can slide freely along the shaft because the non-circular hole in the threaded collar conforms to the cross-sectional shape of the shaft attached to the bottom plate. The bases of the three alignment grooves provide three points of support and stability to the upper plate like that of a milking stool.

As shown in FIG. 7, the upper section of the double nut has internal threads that engage threads on the shaft. The lower portion of the double nut has internal threads that engage the threaded collar. A double nut moves up and down the shaft when rotated. When collar threads in the lower portion of the double nut engage threads on the threaded collar, the top plate becomes fixed in position, but is not yet firmly supported. The top plate becomes firmly fixed in position when the base of the double nut contacts the top plate. In this embodiment, one alignment groove is made larger than the others so that the top plate cannot be placed on the shaft with holes and notches out of alignment.

The top plate slides freely along the shaft when not engaged by the double nut. Users measure the length of bit extending beyond the jaws of the drill chuck, then subtract the desired hole depth to obtain what is termed the separation distance, delta. Users then position the top plate on the shaft so that the distance between the top of the top plate and the bottom of the bottom plate is equal to delta. Depth graduations are marked on the shaft, so it is not necessary to physically measure the distance between plate surfaces. Users simply position the top plate on the shaft so that the top of the collar is aligned with the proper depth graduation. Users fully thread the double nut onto the threaded collar fixing the top plate in the position for drilling to a particular depth. Partial engagement between threads in the double nut and threads on the collar fix the top plate in position. Fully advancing a double nut until its base strikes the top plate stabilizes the top plate on the shaft.

Users can visually mark planned hole locations on work surfaces using, for example, a pencil or punch. They may also drill into the working surface at the marked location just sufficiently to physically mark the location. If drilling depth is large, a great length of bit will extend below the bottom plate when the bit is fully inserted into the proper holes in the top and bottom plates. Users can simply insert the bit into the marked location while holding the drill guide above the working surface so that they can observe that the bit is properly located. After the bit has been properly seated into the marked location, users can lower the drill guide to the working surface and drill the hole.

When drilling very shallow holes, it may be necessary to view marked hole locations through the holes in the top and bottom plates with no bit being placed within the drill guide. This technique is most useful when drilling large diameter holes. Alternatively, users can insert a rod of the same diameter as the bit held within the chuck jaws into the selected holes in the drill guide, place the point of the rod on the marked hole location, then lower the drill guide down to the working surface. Users then withdraw the rod, insert the drill bit into the drill guide, and operate the drill with one hand while holding the drill guide with their other hand until the jaws meet the top plate. Holes aligned perpendicular to working surfaces are thus drilled to proper depths.

There is no marring of working surfaces because rotating jaws of drill chucks do not contact working surfaces. Splintering of wood is reduced because bottom plates bear down on working surfaces while holes are being drilled.

Depth adjustments can be made without fully disassembling the drill guide and without using tools, so there is little risk that drill guide components or tools will get lost. Many depth stop tools involve sleeves or similar devices that cover great lengths of drilling tools and increase the length of drilling tool required to reach great depths of drilling. This invention does not employ sleeves or collars that attach to drilling tools. The entire length of bit exposed beyond the drill chuck, except for the combined thickness of the top and bottom plates of the drill guide, can be used in drilling holes. The top and bottom plates of the drill guide can be thin; thus, this invention allows users to drill holes to the nearly the full length of their drilling tools. This invention reduces the need for users to purchase long drilling tools.

Drill Guide with Canting Base Attachment

The shanks of drilling tools having bits that are larger than their shanks can be placed against corresponding notches in the two plates of the drill guide. However, the drill guide must be raised above the working surface to provide the space necessary for the bit. This can be done by placing a simple wood block near the planned hole location, then placing the drill guide on the wood block. However, this provides less versatility and stability compared to that provided by the canting base attachment because the canting base has a drill bit recess in its front end and a grooved base that allows for drilling holes through cylinders.

Users first place the drill bit point on the working surface at the proper location. The canting base assembly (drill guide and canting base attachment) is then moved into position so that the proper semi-circular notches engage the shank. Holes can be drilled to prescribed depths that are aligned perpendicular to the working surface using the canting base assembly.

Inclined holes can be drilled into flat working surfaces using the canting base assembly and appropriate drilling tools. Users lower the canting shaft below the bottom surface of the canting base attachment so that the canting base is properly inclined when placed on the working surface, then secure the canting shaft by turning the knob at the rear of the canting base closing the gap and fixing the shaft in place. The angle graduation on the canting shaft aligned with the top of the canting base attachment indicates the actual angle of inclination.

Users mark the planned hole location on the working surface, then strike a line that is aligned with the plane passing through the drill bit when properly inclined and oriented. Users place the canting base assembly on the working surface with the bit point at the planned hole location and center alignment notch in the canting shaft edge positioned on the line. Users then operate the drill creating a hole of the correct depth, inclination, and alignment.

Holes can be drilled through the center of large and small cylinders using the canting base assembly in fields and shops. Cylinders do not need to have free ends that allow users to insert them into existing devices. Holes can be aligned perpendicular to, or inclined from, the cylinder's axis. The canting base automatically aligns itself with the longitudinal axis of cylinders when placed upon them because the canting base has a grooved bottom surface that runs from front to rear. No tools are required for this operation.

In most cases, users can verify that the canting base assembly is at the proper point on the cylinder by visually observing that the drill bit point is at the marked hole location. Angles of inclination must be measured, not read from the angle graduations, when drilling into cylinders. If field conditions do not permit direct viewing of the marked point and drill bit point while drilling the hole, users can position the canting base assembly on the cylinder so that a rod inserted through the selected holes in the drill guide strikes the marked hole location, then mark a new target point on the cylinder beneath the center alignment notch in the canting shaft edge. Users then hold the drill in one hand and the canting base assembly in the other hand while holding the center notch over the target point.

Drill Guide with Dowel Jig Attachment

This invention comprising a drill guide with dowel jig attachment allows users to drill multiple equally spaced-apart and accurately aligned dowel holes to precise depths into the edges and faces of planar work pieces. Dowel holes will be automatically aligned at some constant distance from an edge, evenly spaced apart by gauged distances, and aligned perpendicular to work surfaces.

In this preferred embodiment, the dowel jig and alignment system combine to allow users to drill up to five evenly spaced and properly aligned dowel holes at one jig setup location in the edges or faces of planar work pieces. The jig's center and outboard blocks move in unison along parallel grooved tracks. Outboard sliding blocks can be shifted left and right relative to the center sliding block providing numerous gauged spacing distances between dowel holes. This invention supports the use of standard dowel spacing intervals by providing jig spacing index notches on the back wall of the dowel jig body, center notches on the adapters, and compatible groove widths in the surfaces of the dowel jig body. For example, there is a European standard spacing of 32 mm, and a US standard spacing of 1¼ inches. This invention can support either of these standard spacings, but not simultaneously. This invention can support numerous non-standard spacings.

The front faces of the sliding blocks are in the same plane as the drill bit and allow users to accurately position dowel holes at marked locations. This invention provides infinite control over position relative to the thickness of an edge, and numerous gauged spacing distances.

The dowel jig attachment has one pin adapter and multiple blank adapters that can be easily attached to and separated from sliding blocks. An adapter flange slot formed in the bottom surface of each adapter engages the adapter fixture projecting from the top surface of each sliding block. Users attach adapters to sliding blocks by sliding them on and off. The adapters are held firmly in place in five of six possible directional movements (up, down, left, right, and rearward) when attached. Users can freely slide the adapters forward to disengage them from the sliding blocks.

Pin adapters have a center index pin and two alignment pins that project upward from their top surfaces whereas blank adapters have no projecting alignment pins. Alignment recesses in the bottom surface of the bottom plate of the drill guide engage the projecting pins on the pin adapter effectively attaching the drill guide to the dowel jig. Pin adapters and blank adapters can be attached to any of the sliding blocks.

Users mark a first dowel hole point on and edge of a work piece, then mark orthogonal lines through the point aligned parallel to (horizontal line) and perpendicular to (vertical line) the edge forming a large plus sign. The dowel jig attachment with its brace but with no adapters is attached to the work piece with the center line groove in the selected sliding block lined up with the vertical line of the plus sign. The clamp rod is then rotated until the jig is firmly secured to the work piece. The dowel jig is then correctly positioned relative to the vertical line. The control rod is then rotated until the front face of the sliding block lines up with the horizontal line of the plus sign. The dowel jig is then properly positioned to drill dowel holes.

The left-most or right-most sliding outboard block will typically be selected as the starting point. Thus, the pin adapter will typically be first attached to one of those outboard sliding blocks. Blank adapters will be attached to the other sliding blocks. The pin adapter, adjacent blank adapters, and side walls of the dowel jig support the drill guide vertically and horizontally during drilling operations. However, users must apply a small rearward force on the drill guide while drilling to maintain proper engagement between the pin adapter and the selected sliding block. Users position the drill guide on the pin adapter with the appropriately sized hole centered over the planned dowel hole location, then drill the hole. Users swap the pin adapter and the adjacent bank adapter in position, then drill the next dowel hole. If more than five dowel holes are to be drilled, users can drill five holes at a first position, then move the attachment to a new position that aligns the first new dowel hole with the last hole drilled. The dowel jig attachment can then be reattached to the work piece allowing more holes to be drilled at the same spacing.

When drilling holes in the faces of work pieces, a straight edge tool (standard) is fastened to the face of the work piece with its long axis aligned parallel to, but offset from, the planned line of dowel holes. The dowel jig attachment is then clamped to the standard in the proper position. The control rod is then rotated until the center groove in the selected sliding block and front face of the sliding block are properly aligned with the plus sign over the marked dowel hole location.

Clamping of a dowel jig attachment to a work piece or the standard allows users to more accurately locate and drill holes to prescribed depths and orientations, and to do that work safely as both hands can be used to hold and stabilize the drill and drill guide. This invention allows the drilling of equally spaced dowel holes of multiple sizes to prescribed depths that are perpendicular to work pieces.

### OTHER EMBODIMENTS

Other embodiments can be produced that may prove to be beneficial in terms of production cost, durability, and/or functionality. For example, the threaded shaft on the drill guide can be replaced by a smooth cylindrical shaft if a sufficiently strong clamping device is used to secure the top plate to the shaft. This approach would perhaps be better if the two plates were composed of metal rather than plastic. Such an embodiment would provide infinite control of depth whereas the preferred embodiment allows users to position the top plate with an accuracy about equal to the pitch of the threads on the shaft. The preferred embodiment rigidly holds the top plate in position on the shaft with no risk of slippage.

The top and bottom plates of the drill guide shown in the preferred embodiment can be composed of thermal set plastics and can function as bushings. The top and bottom plates can be configured to act as metal bushing carriers in another embodiment. In this embodiment, the top and bottom plate will support thin metal bushings of variable sizes. In yet another embodiment, the entire drill guide can be composed of metal.

In yet another embodiment, top and bottom circular plates in the preferred embodiment can be replaced by triangular plates that serve as bushing carriers. A large hole can be formed near each of its three apexes that holds a metal bushing. A V-shaped notch at each apex can replace the semi-circular notches in the preferred embodiment. The number of alignment recesses would be reduced to just three. Three different bushing sizes can be available for use at any point in time. Such an embodiment would have the same functionality as the preferred embodiment, would have a much longer service life, but would be more costly to produce.

Thin metal sheets having punched holes can be placed on the top or bottom surfaces of the top and bottom plates to serve as bushings. These will extend the service life of drill guides at a relatively low cost.

The sliding blocks and adapters of the preferred embodiment can be incorporated into one, fully rectangular body having a hole near its outer end that supports replaceable metal bushings of various internal diameters. There is no need for a pin adapter with this alternative embodiment. However, a conventional collar-type depth stop must be attached to the bits if drilling depth is to be controlled. Dowel holes can be drilled without using the drill guide with this embodiment. This embodiment becomes an independent invention not linked to the drill guide.

### Method of Manufacture

This invention, save metal rods, inserts, nuts, and other small components, can be composed of thermal set plastics produced using injection molding techniques. Some limited post-injection processing may be required for the attachments. For example, it might be desirable to install hollow, cylindrical metal inserts having external and internal threads in holes formed in plastic components that will engage threaded metal rods.

Alignment grooves in the shaft of the drill guide in the preferred embodiment are formed using straight lines. Alignment grooves can have other shapes, including semi-circular, to enable more efficient or practical fabrication.

Thin metal discs having the same fully circular holes and semi-circular notches as those produced in plastic top and bottom plates, but slightly undersized, can be incorporated into the production of parts produced using injection molding. These metal plates would likely be placed into the injection mold before injection takes place. Alignment recesses can be punched or drilled into the bottom plate. Alternatively, metal plates might be affixed to the top and bottom plates after injection using a thermal process. Metal bushings can be incorporated into the top and bottom plates to extend the life of the drill guide. This invention can also be produced using mostly metal components. The shaft might be formed on lathe or NRC machine In this way, a more durable tool can perhaps be produced.

Plastics used in injection molding processes should have high strength, hardness, and a high melting temperature. Thermal set plastics do not change shape when heated to moderate temperatures that might be produced by hot bits. The drill guide can be formed using ceramic materials for little cost that have high durability and are non-conductive.

### ADDITIONAL EMBODIMENTS

Disclosed below are drilling assist systems including three new drill guide and depth-stop tools named Multiguide 11A, Triguide 37A, and Uniguide 47A (hereinafter drill guides) stemming from the original drill guide invention described above. These new drill guides, without attachments, allow users to drill holes to precise depths perpendicular to flat working surfaces and alleviate certain deficiencies of the original drill guide invention that became evident to the inventor after filing of the parent application.

### Multiguide

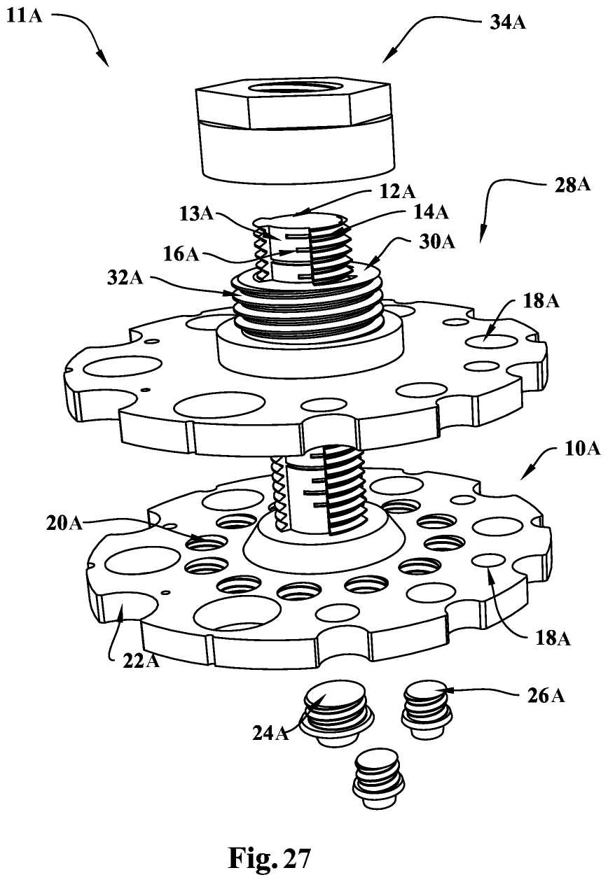

FIG. 27 shows four primary Multiguide components (top plate 28A, bottom plate 10A with integral threaded shaft 12A and double nut 34A in an exploded view). Shaft threads 14A are interrupted by longitudinal alignment grooves 13A. Depth graduations 16A are formed in alignment grooves. Multiple fully circular bushing holes 18A, and multiple semi-circular edge notches 22A are formed in both the top and bottom plates. Bushings and notches in the two plates are configured to be aligned with each other.

A collar 30A integrally formed with the top plate has external threads 32A that engage the double nut 34A shown above the shaft. The double nut has an upper set of internal threads that engage the shaft threads 14A and a lower set of internal threads that engage the collar connecting threads 32A.

A centering pin 24A shown directly below the center of the bottom plate can be installed in a threaded hole in the bottom surface of the bottom plate. A pair of alignment pins 26A are shown spaced apart from the center pin by a constant radial distance and spaced apart from each other by an angular distance. Threaded ends of alignment pins can be installed in threaded alignment pin holes 20A in bottom plates that surround the shaft 12A.

Two alignment pins are configured to be removably secured in Multiguide if it is used with an attachment. A centering pin 24A is installed in a threaded hole in the center of the bottom face of the Multiguide if it is to be used with the dowel jig. The centering pin is replaced with a connecting bolt (not shown in this view) if Multiguide is attached to a canting base.

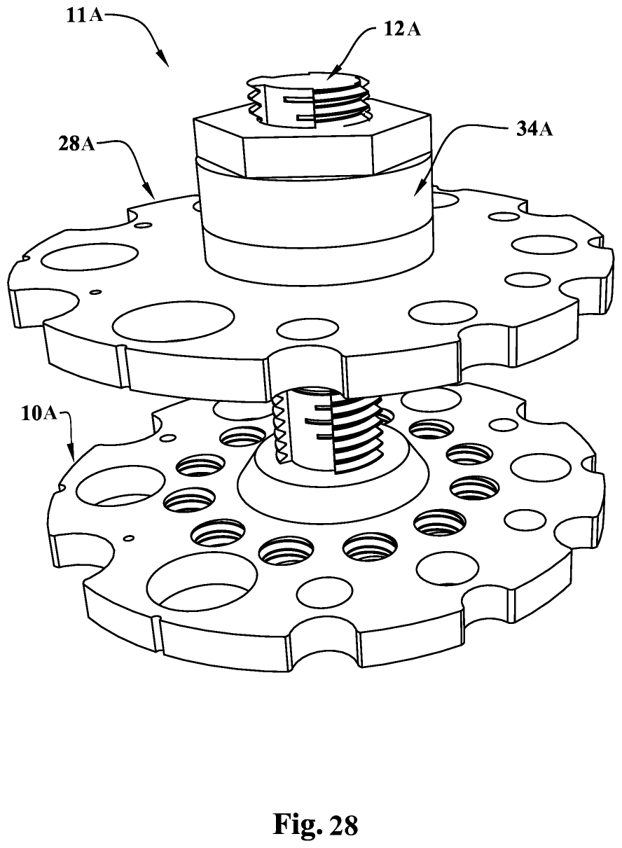

FIG. 28 shows a top-isometric view of the assembled Multiguide 11A. The bottom plate 10A, top plate 28A, and double nut 34A move as a unit when the double nut is secured to the shaft 12A and integral collar 30A (visible in FIG. 27) of the top plate.

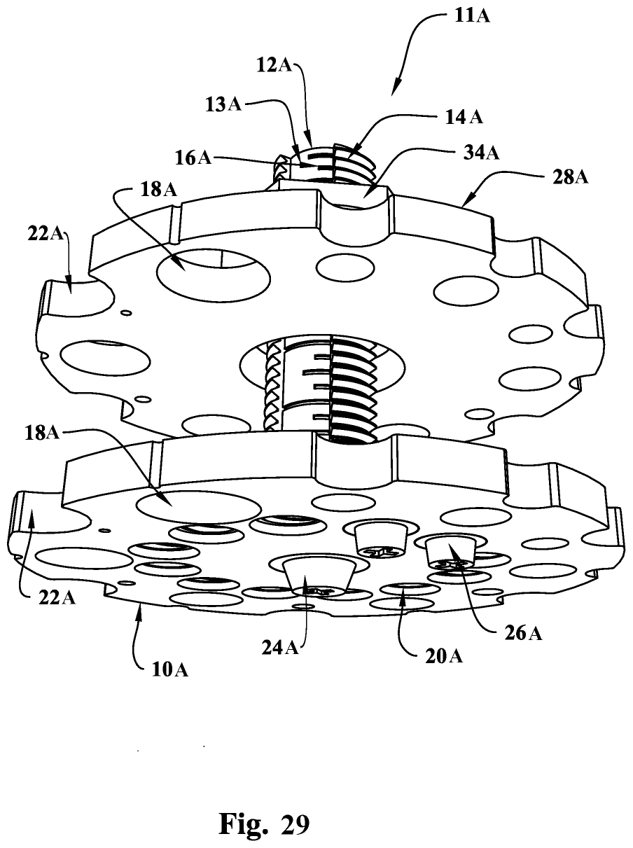

FIG. 29 shows a bottom-isometric view of the assembled Multiguide 11A that includes a bottom plate 10A with integral shaft 12A, top plate 28A with integral collar 30A (visible in FIG. 27), and a double nut 34A. Bushings 18A and semi-circular edge notches 22A are formed in top and bottom plates. The top plate 28A is slidingly connected to the shaft 12A and secured in position by the double nut 34A. Shaft threads 14A are seen interrupted by longitudinal alignment grooves 13A that maintain alignment of bushings in top and bottom plates. Depth graduations 16A are formed in a shaft alignment groove 13A. A centering pin 24A is seen installed in a threaded recess in the center of the bottom plate 10A. A multiplicity of alignment pin holes 20A are formed in the bottom plate. Two alignment pins 26A are installed in two threaded alignment pin holes in the bottom surface of the bottom plate.

### Triguide

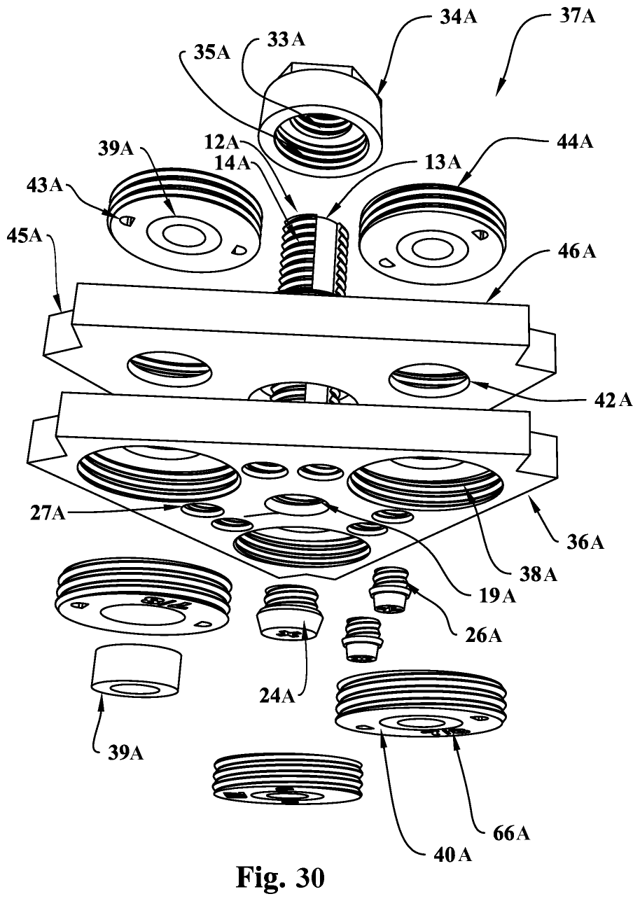

FIG. 30 shows a vertically exploded isometric view of Triguide which has a bottom plate 36A, top plate 46A, double nut 34A, three upper bushing inserts 44A, and three lower bushing inserts 40A. The top Triguide plate is slidingly connected to the shaft 12A that is rigidly attached to the bottom plate and has external threads 14A interrupted by longitudinal alignment grooves 13A.

The upper portion of a double nut 34A has internal threads 33A that engage shaft threads, and the lower portion has larger internal threads 35A that engage collar threads. The double nut secures the top plate 46A to the shaft 12A when the double nut is threaded onto the collar of the top plate (not visible in this view).

Three clockwise (CW) threaded lower bushing insert holes 38A are formed in the bottom surface of the bottom plate. Each such threaded hole receives a threaded lower bushing insert 40A. Likewise, three CW threaded upper bushing insert holes 42A are formed in the top surface of the top plate 46A that receive a threaded upper bushing insert 44A. Triguide utilizes CW threads because it has rims to prevent bushing rotation and because it is more convenient to have CW threads on Triguide bushing inserts (versus CCW threads). Triangular edge notches 45A are formed at each apex of both the top and bottom Triguide plates that serve as partial bushings for drilling tools having bits that are larger than their shanks.

A threaded centering pin hole 19A is formed at the center of the bottom surface of the bottom plate. Three pairs of threaded alignment pin holes 20A are formed in the bottom surface of Triguide's bottom plate at a constant radial distance from the shaft. Each pair of alignment pin holes in this embodiment is paired with the threaded lower bushing insert hole 38A located on the opposite side of the shaft. Each bushing insert (40A and 44A) has a bushing 39A and a size label 66A. Two alignment pins 26A and a center pin 24A can be seen in alignment with corresponding holes.

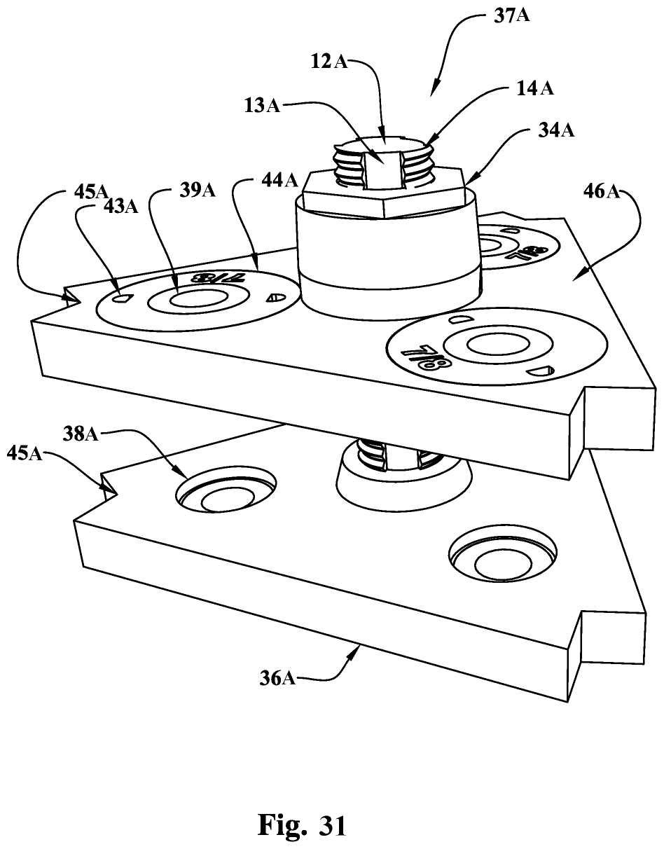

FIG. 31 shows a top view of the assembled Triguide 37A. The shaft 12A, top plate 46A, bottom plate 36A, upper bushing inserts 44A, and bushings 39A are visible in this view. CCW threads are in all cases. Bushing size is indicated by a bushing size label 66A. A lower bushing insert 40A is installed in each of three lower bushing insert holes 38A. A threaded upper bushing insert 40A is installed in each of three upper bushings holes 42A in the top plate. A bushing is installed in each bushing insert. A triangular edge notch 45A is formed at each apex of the two plates. The double nut 34A secures the top plate to the collar 30A and shaft 12A. An alignment groove 13A and shaft threads 14A are also visible. Plate separation and length of drill bit extending beyond the drill chuck determine hole depth.

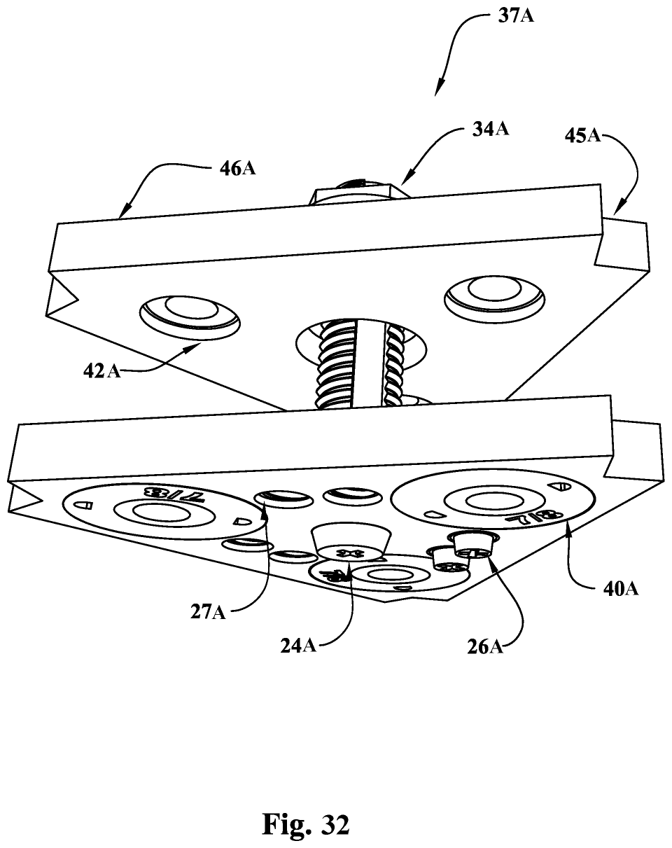

FIG. 32 shows the assembled Triguide 37A as viewed from below. A double nut 34A secures the top plate 46A to the shaft 12A. Three lower bushing inserts 40A with bushings 39A, a pair of alignment pins 26A, and one centering pin 24A can be seen installed in the corresponding threaded holes. Threaded lower bushing inserts are installed from below. Their faces are even with the bottom plate surface when fully installed. Threaded upper bushing inserts 42A with bushings 39A are installed in the top surface of the top plate. Edge notches 45A serve as partial bushings for drilling tools having bits that are larger than their shanks. Three different bushing sizes can be installed at one time.

### Uniguide

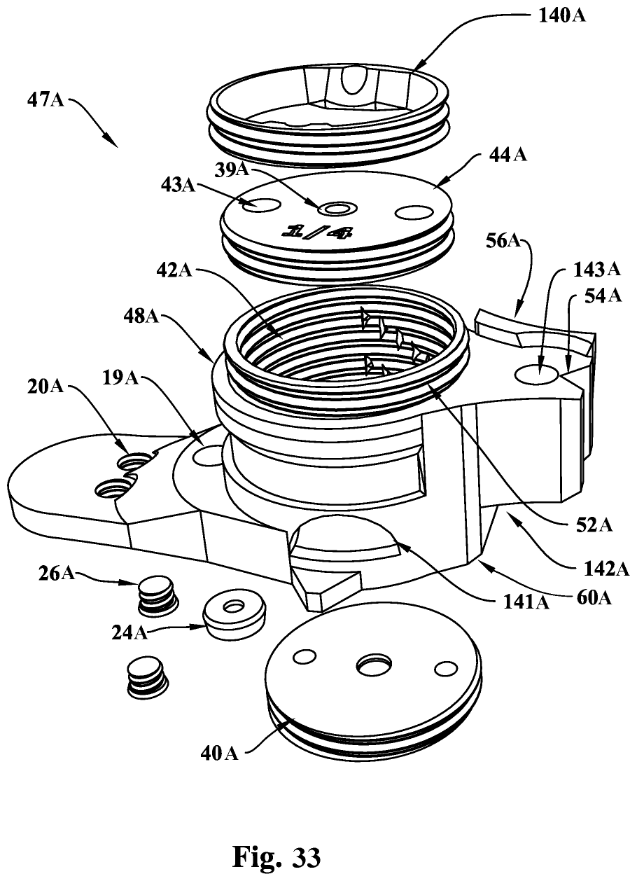

FIGS. 33-35 show views of a Uniguide assembly 47A that is composed of a Uniguide body 48A, one optional segment 50A, an upper threaded bushing insert 44A, an insert locking ring 140A, and one lower threaded bushing insert 40A. Bushings 39A are installed in each bushing insert with an interference fit. Bushing inserts have CCW threads and bear against locking rings to prevent bushing insert rotation during CW drilling operation. Uniguide bushings must be large enough to allow a drill chuck mechanism to fit within the body of the Uniguide. The Uniguide body can be used with no segments or with many segments. These views show that the Uniguide body has external connecting CCW threads 52A, a threaded upper bushing insert hole 42A, two threaded alignment pin holes 20A, a Uniguide edge notch 54A, a stop block 56A, and a beveled face 60A that is interrupted by a Forstner bit recess 142A.

Each segment 50A has a threaded upper bushing insert hole 42A, an edge notch 54A, a stop block 56A, and a stop block projection 58A.

A threaded upper bushing insert 44A can be installed in either the top-most segment or, if no segments are installed, the Uniguide body. A threaded lower bushing insert 40A is installed in the threaded hole in the bottom of the Uniguide body when drilling tools have bits and shanks of the same diameter. Two bushing rotation tool holes 43A are formed in each bushing insert, and a bushing size label 66A is formed on one face of each bushing insert.

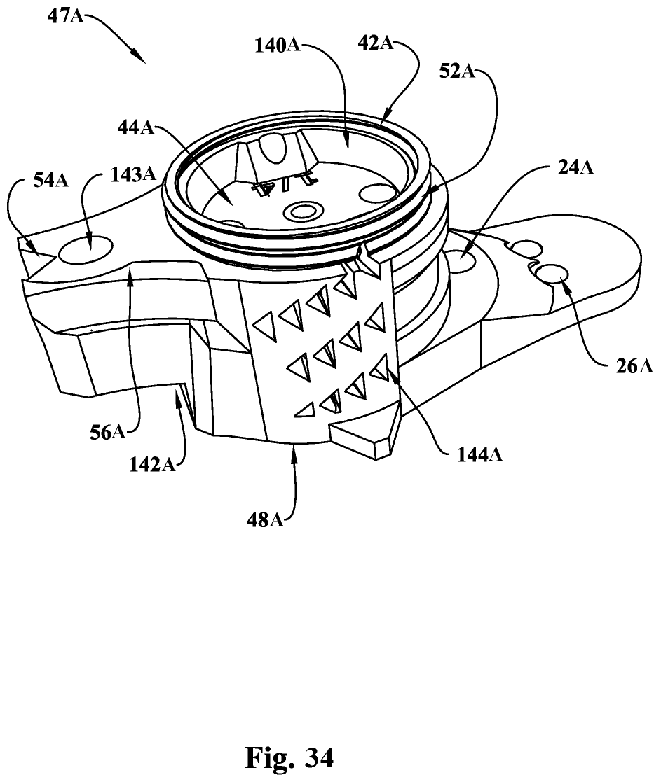

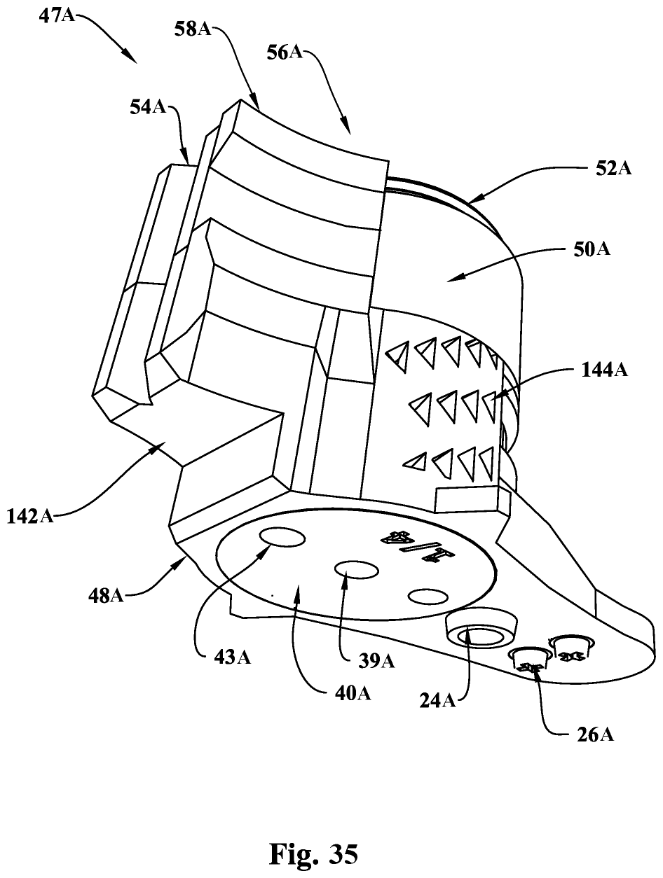

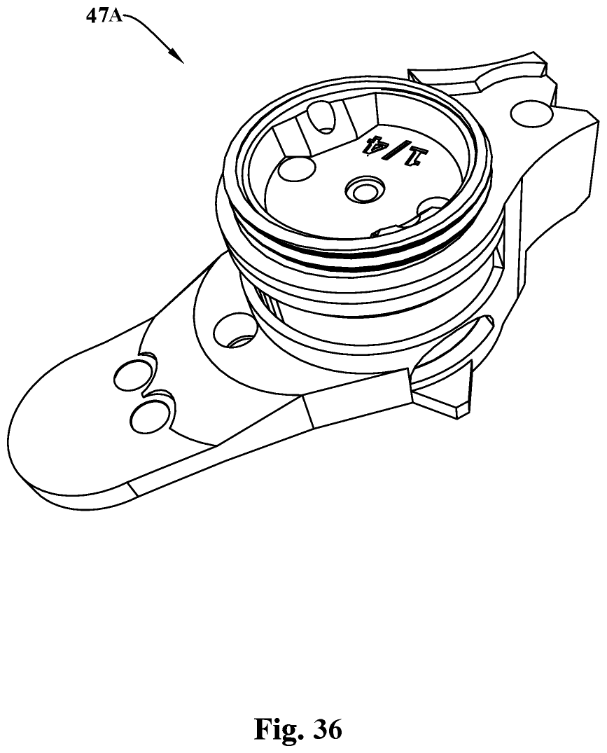

FIG. 34 shows a top isometric view of a Uniguide assembly. The upper bushing insert 44A is installed in the upper bushing insert hole 42A in the segment 50A or the Uniguide body 48A so that the desired hole depth is achieved when the drill chuck meets the bushing 39A in the upper bushing insert. The bushing size label 66A is marked on each bushing insert. In this embodiment, two bushing rotation tool holes 43A allow users to rotate the bushing insert using, for instance, a needle nose pliers. An insert locking ring 140A prevents upward movement of the upper bushing insert due to friction between drill bits and bushings. Hard drill chuck stops 143A prevent damage to segments and Uniguide bodies when rotating drill chucks contact them. Segments 50A are installed on Uniguide bodies by threading them in a CCW direction.

A stop block 56A and stop block projection 58A force proper alignment of edge notches 54A. Two threaded alignment pin holes 20A are visible in the Uniguide body. A cuttings port 141A is formed in one side of the Uniguide body just above the top of the bottom bushing insert.

FIG. 35 shows a bottom isometric view of a Uniguide body 48A with one segment 50A optionally added forming an assembly. A threaded lower bushing insert 40A is shown installed in the bottom of the Uniguide body. When installed fully into the threaded hole, the bottom face of the lower bushing insert is flush with the bottom face of the Uniguide body.

A beveled face 60A allows the Uniguide body and canting base attachment to rotate without undue restriction. The centering pin 24A and two alignment pins 26A are installed in the corresponding threaded holes in the bottom face of the Uniguide body. When properly assembled, notches 54A in the Uniguide body and segments align. Multiple segments can be added via the external connector threads 52A. The top bushing insert threaded hole is visible through the cuttings port 141A.

FIG. 36 shows an assembled Uniguide viewed from above.

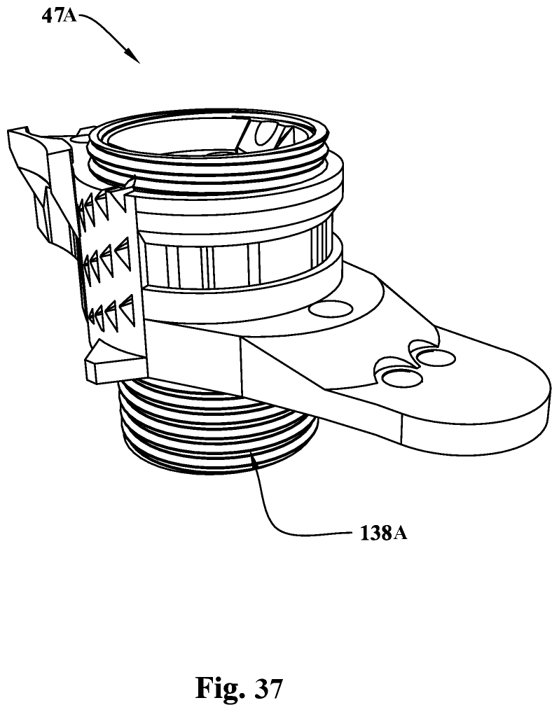

FIG. 37 shows a view of the Uniguide body 48A with a threaded jack 138A installed in place of the top and bottom bushing inserts. The jack moves the Uniguide body upward until the top of the edge notch 54A is positioned for the correct hole depth. Drill bits stop advancing when drill chucks meet the drill chuck stop 143A.

### Canting Base Attachment

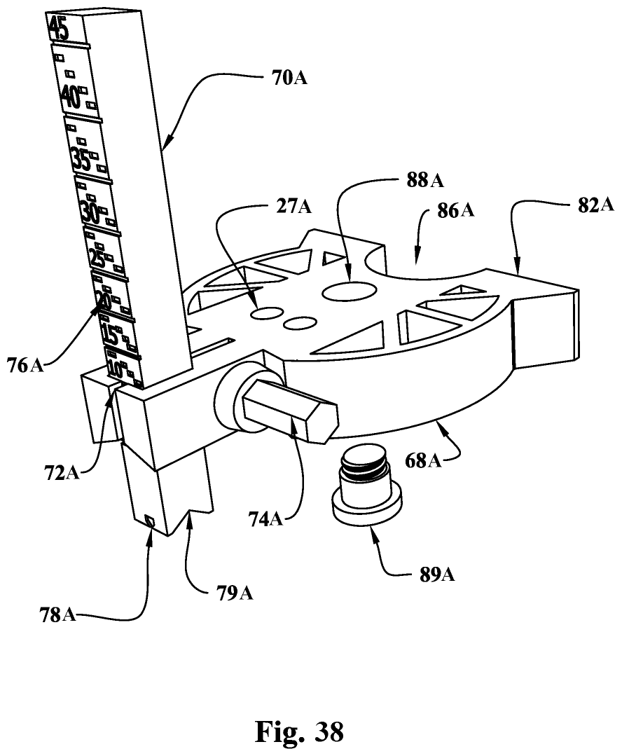

FIG. 38 shows a top-rear isometric view of a canting base attachment 68A with a canting shaft 70A secured in the canting base shaft slot 72A by the canting base clamp 74A. Angle graduations 76A are marked on the canting shaft that can be used when drilling into flat working surfaces.

A canting base shaft center point 78A formed in the bottom end of the canting shaft can be used when drilling into flat surfaces to aid in aligning the canting base. The canting shaft will be installed in the canting base slot with angle graduations facing to the left or right rather than the rear when drilling into cylinders. The canting base cylinder shaft notch 79A aids in aligning the canting base on cylinders.

A canting base bolt hole 88A fully penetrates the canting base attachment at its center. A canting base bolt 89A is shown directly below the bolt hole. Two alignment pin recesses 27A are formed in the top surface of the canting base. A drill bit recess 86A is formed in the front face of the canting base attachment.

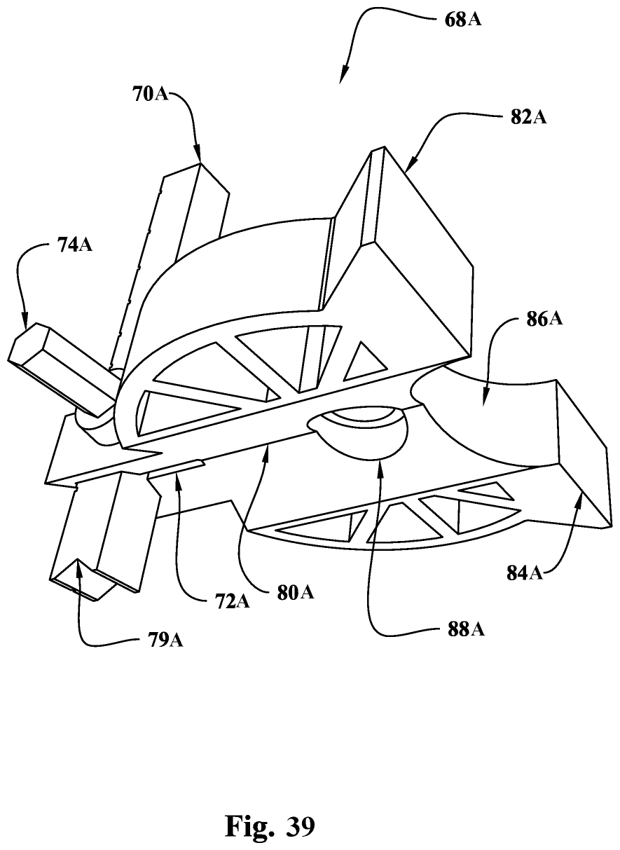

FIG. 39 shows a bottom-front isometric view of the canting base attachment 68A. The canting base groove 80A and the canting base bolt hole 88A are visible in the bottom surface of the canting base. The canting base pivot edge 84A is visible at the bottom of the front face 82A. The canting base shaft slot 72A is also visible at the apex of the groove. The shaft 70A can move up and down in the slot except when clamp 74A is tightened. The drill bit recess 86A is visible at the front end of the canting base. The canting base shaft cylinder notch 79A conforms the attachment to cylinders when the shaft is rotated 90° in the slot so that angle graduations face to the left or right side of the attachment.

### Dowel Jig Attachment

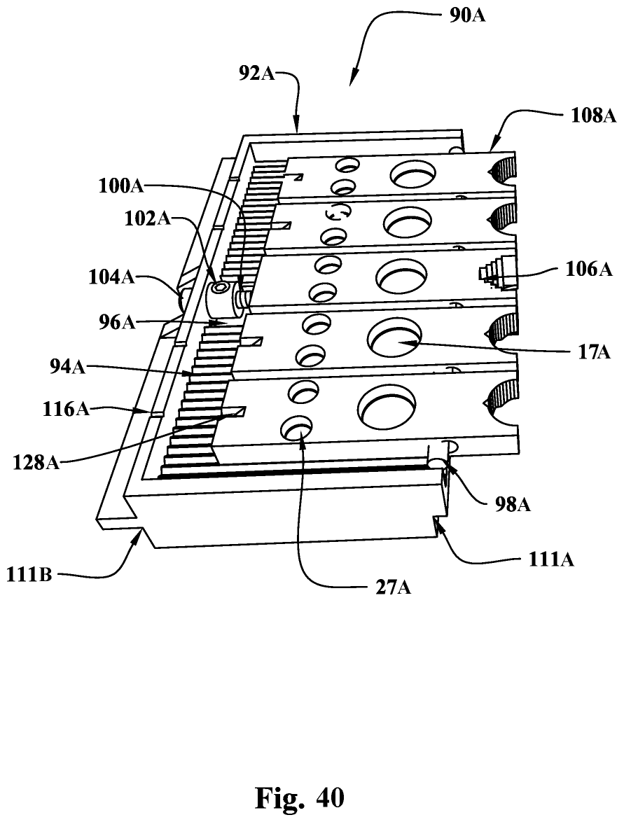

FIG. 40 shows a top isometric view of a dowel jig assembly 90A that includes the dowel jig body 92A, center sliding block 106A, and four outboard sliding blocks 108A as shown in this embodiment. The center sliding block slides forward and back within the center sliding block groove 96A formed in the top surface of the dowel jig body. The outboard sliding blocks move forward and backward on the dowel jig alignment grooves 94A that engage grooves in the bottom surface of the outboard sliding blocks. These alignment grooves prevent lateral movement of outboard sliding blocks and insure graduated spacings.

All sliding blocks are held in fore-and-aft position by a threaded position rod 100A and a sliding block locking rod 98A that passes laterally through each sliding block.

The threaded position rod 100A is operated by turning a sliding block position control knob 104A acting against the back wall of the dowel jig body and a locking collar with set screw 102A. A pair of threaded dowel jig clamp rods, dowel jig clamps, and dowel jig clamp knobs, or other clamping devices may be used to secure the dowel jig body to workpieces.

A centering pin recess 17A and two alignment pin recesses 27A are formed in the top surface of each sliding block. A sliding block center mark 128A is formed in the center of the back edge of each outboard sliding block. Standard spacing alignment notches 116A are formed in the back wall of the dowel jig body that align with the sliding block center marks when using standard spacings.

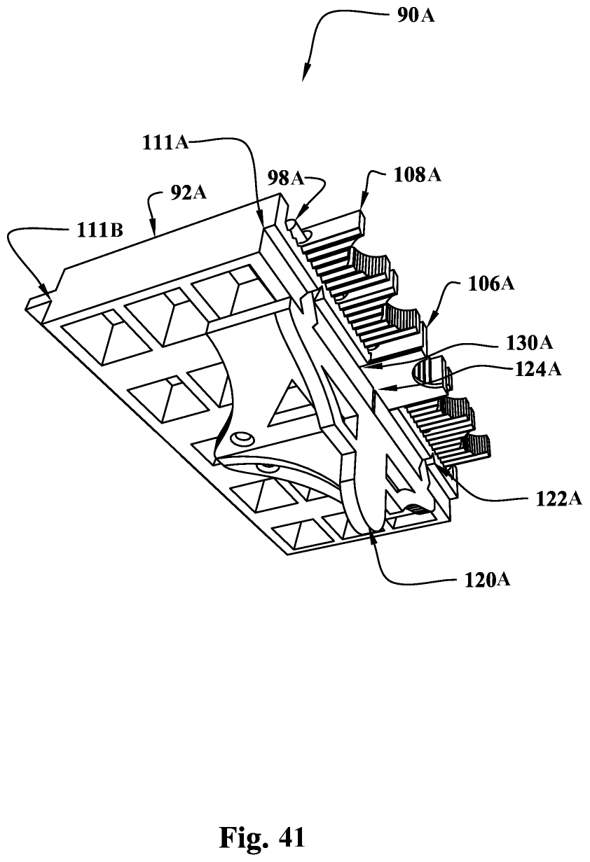

FIG. 41 shows a bottom isometric view of the dowel jig assembly 90A with the dowel jig brace 120A that is attached when drilling dowel holes into edges of workpieces. The dowel jig alignment edge 111A is visible near the front edge of the dowel jig body. The center sliding block 106A is seen to have a flat bottom surface while the outboard sliding blocks 108A have grooved bottom surfaces. A dowel jig center mark 124A is seen on the front face of the dowel jig body beneath the center sliding block. Dowel jig alignment grooves 94A are visible on the bottom surfaces of outboard sliding blocks.

Dowel jig engagement fittings 123A on the top surface of the dowel jig brace 120A slide into dowel jig brace engagement slots 122A formed in the bottom of the dowel jig body. A center sliding block flange groove 130A is formed on both sides of the dowel jig center groove 96A. Center sliding block flanges 132A formed on the long bottom edges of the center sliding block engage the sliding block flange grooves and prevent upward and downward movement of center sliding blocks.

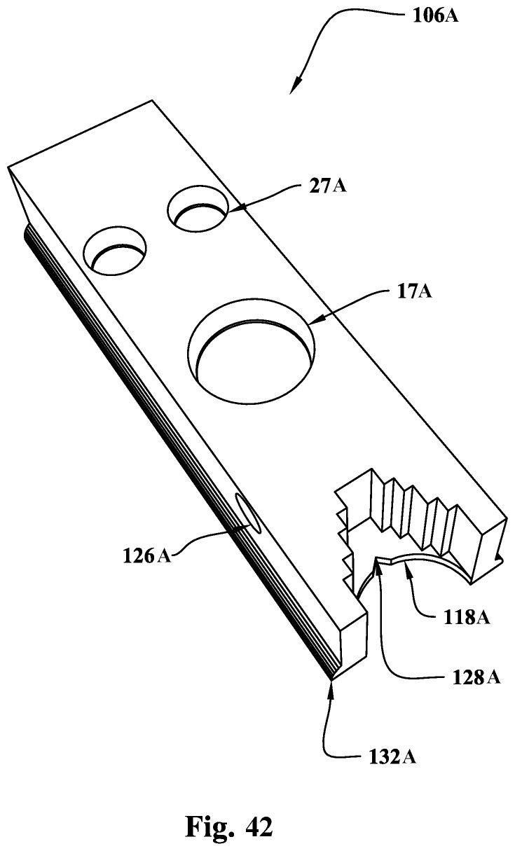

FIG. 42 shows a top-front view of a center sliding block 106A. A center sliding block flange 132A is formed on each long bottom edge of the center sliding block. A sliding block locking rod hole 126A passes laterally through all sliding blocks. A centering pin recess 17A is formed on the axial center line at a specified distance from the front face each sliding block. Two alignment pin recesses 27A are shown in the top surface of each sliding block in this embodiment. Likewise, a center pin recess 17A is also visible in the center of each sliding block. A sliding block center mark 128A is formed in the rim of the dowel jig drill bit recess 118A at the longitudinal center of each sliding block. The intersection of a vertical plane passing through the longitudinal center of the sliding block and a second vertical plane passing through the front face of the sliding block marks the drill bit location.

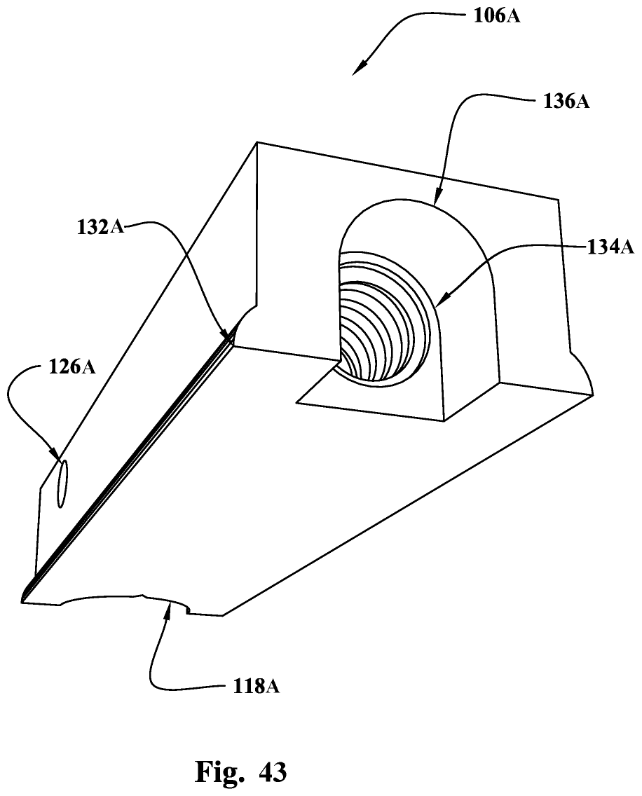

FIG. 43 shows a bottom-rear isometric view of a center sliding block 106A. A locking collar recess 136A is formed in the rear of the center sliding block that allows the sliding block to pass over the locking collar (102A seen in FIG. 12). A threaded position control rod hole 134A extends through much of the center sliding block. Two center block flanges 132A and a sliding block locking rod hole 126A are also visible in this view. The base of the center sliding block is smooth.

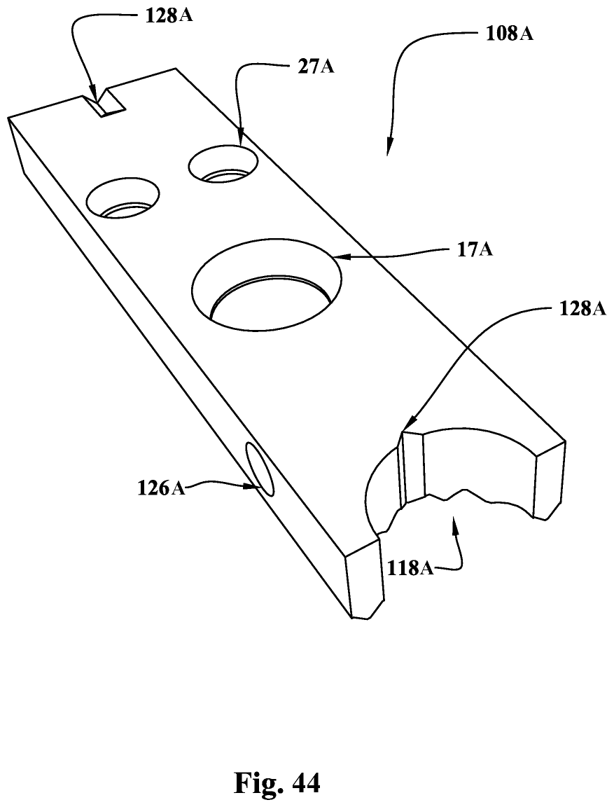

FIG. 44 shows a front-top isometric view of an outboard sliding block 108A. A center pin recess 17A, two alignment pin recesses 27A, and center mark 128A are formed in the top surface of the outboard sliding blocks. A locking rod hole 126A passes laterally through all sliding blocks. A dowel jig drill bit recess 118A and a center mark 128A are formed at the front end of each outboard sliding block.

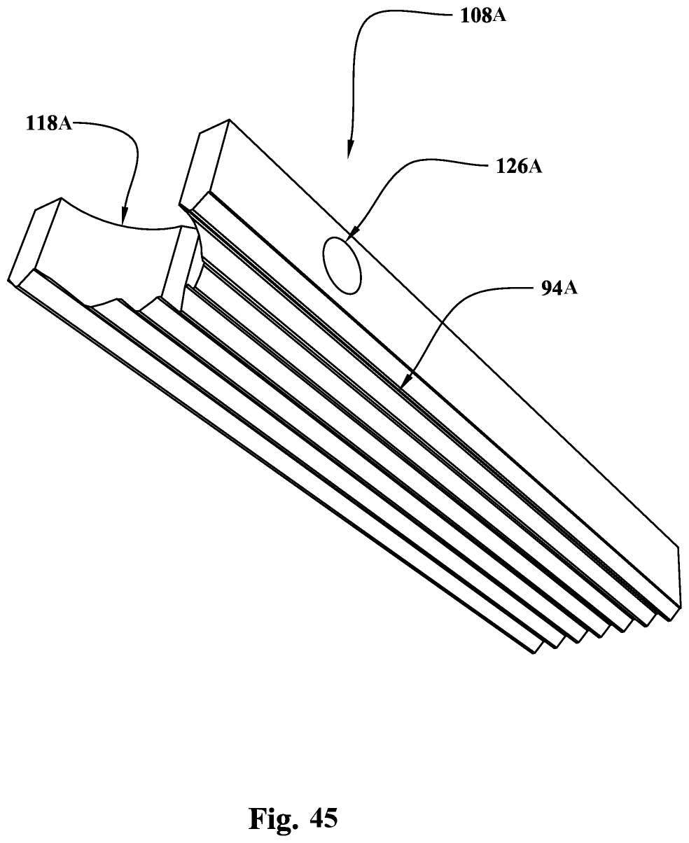

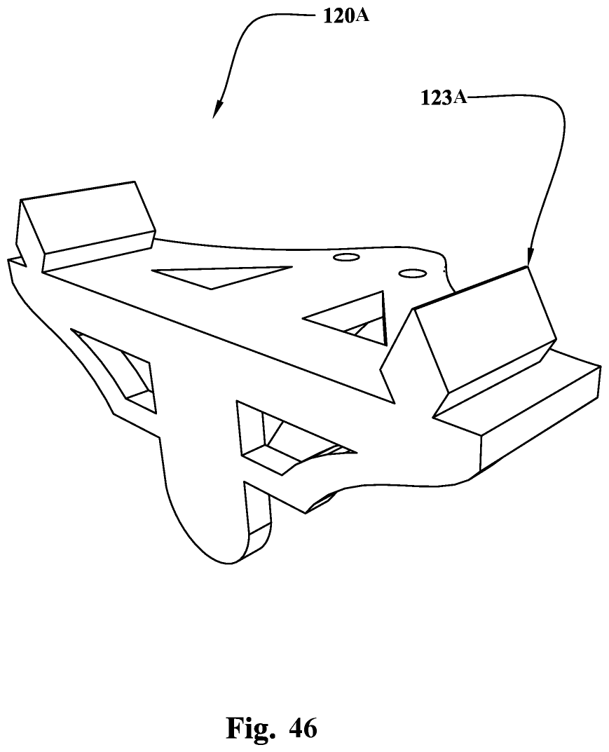

FIG. 45 shows a bottom isometric view of an outboard sliding block 108A. Alignment grooves 94A are formed in the bottom surface of each outboard sliding block.

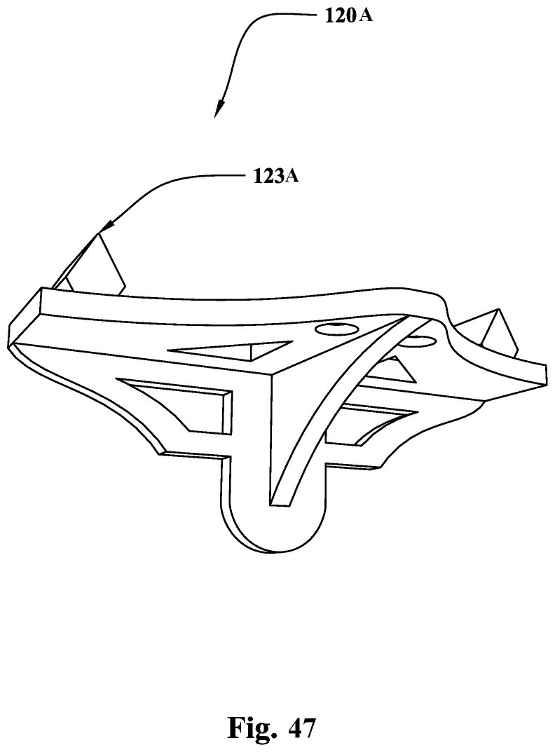

FIG. 46 shows a top-front isometric view of a dowel jig brace 120A. Two dowel jig engagement fittings 123A project from the top surface of the brace. These fittings slide into dowel jig engagement slots (122A in FIG. 39). When fittings are fully inserted into engagement slots, the front face of the brace meets dowel jig alignment edges (111A in FIG. 39).

FIG. 47 shows a bottom-rear view of the dowel jig brace 120A. The rear side of the dowel jig engagement fittings 123A are visible in this view. In this embodiment, the single gusset supports the two plates that form the brace. External clamps can bear upon the plate adjacent to and below the gusset plate.

### Description of Operation

### Depth Adjustment

In the stickup method, users install the bit in the drill chuck, fully insert the bit into the appropriate drill bit bushing, then position the drill guide assembly (drill guide only or drill guide and attachment) on the working surface with the drill bit point resting on that surface. Users measure the stickup length, the length of bit exposed between the top bushing and the drill chuck. Users adjust the position of the top bushing until the stickup length is equal to the hole depth. The stickup method is best employed with Multiguide and Triguide and when using an attachment.

In the stickout method, users fully insert the drill bit into the selected bushing and measure the length of bit sticking out the bottom of the drill guide. Users adjust the position of the top bushing until the stickout length is equal to the desired hole depth.

### Multiguide

The Multiguide invention disclosed in this additional embodiment is operated in exactly in the same way as the drill guide disclosed in the previous embodiments when no pins are installed in the bottom face of the bottom plate. When drilling non-inclined holes into flat workpieces using drilling tools having shanks and bits of the same diameter (twist bits), no pins are installed in the base. Users install the top plate at some convenient location on the shaft and secure it in place with the double nut. Users install a drill bit of the proper size in a drill chuck, select the bushing of the proper size, then adjust the position of the top bushing using either the stickup or stickout methods of depth adjustment until the stickout length is equal to the planned hole depth. Once Multiguide is set up, users fully insert the drill bit into the selected bushing pair, rest the bit point on the working surface at a marked location, lower Multiguide to the surface, then operate the drill until the drill chuck meets the top plate while holding Multiguide firmly.

Multiguide can be set up for just one proper hole depth at a time. However, shallower pilot holes can be drilled using a second drill and a smaller and shorter bit.

Alignment pins must be installed in the base when using an attachment. A connecting bolt must be installed when using the canting base attachment. A centering pin must be installed when using the dowel jig attachment.

When using drilling tools having bits that are larger than their shanks, Multiguide must be placed on a block or the canting base attachment to provide space for the bit. Additionally, users must hold shanks against a pair of edge notches to force proper alignment. Users operate the drill until the drill chuck meets the top plate.

### Triguide

Matching bushing inserts of the right size must be installed in the appropriate threaded holes in Triguide's plate before use. Once these inserts are installed, Triguide is operated exactly like the Multiguide.

### Uniguide

Uniguide can service only one bushing size at a time. One or more segments can be added to the Uniguide body if the planned hole depth cannot be accommodated using just the Uniguide body. Users install a bottom bushing insert in the bottom of the Uniguide body. When properly installed, the bottom surface of the bottom bushing insert will be flush with the bottom surface of the Uniguide body, and the size label will be visible. Users can rotate bushing inserts using the bushing rotation tool holes using, for example, a needle-nose pliers.

Users install a top bushing insert in the top of the Uniguide body or, if one or more segments is attached to the body, the top-most segment. Users can adjust hole depth using the stickup or stickout method as they choose. After Uniguide is set for the proper depth, the locking ring is installed in the top of Uniguide and rotated until it bears on the top bushing insert fixing the bushing insert in place. CCW threads are used throughout Uniguide so that friction between bits and bushing inserts will tend to rotate inserts into contact with the bottom rim or the locking ring.

Users must adjust the height of the notch to set proper hole depth. When using drilling tools having bits that are larger than their shanks, users must first replace bushing inserts with the jack that can raise the top of edge notch to the proper level for depth control. Users hold shanks against the edge notch to force alignment.

Alignment pins and either a centering pin or connecting bolt must be installed in the Uniguide base when using it with an attachment. A connecting bolt is used to connect Uniguide to the canting base attachment, and a centering pin is used to align Uniguide with sliding blocks on the dowel jig attachment.

### Canting Base Attachment

Two alignment pins must be installed in the bottom surface of Multiguide, Triguide, and Uniguide when using them with the new canting base attachment. In the case of Multiguide and Triguide, an alignment pin must be installed in each of two threaded alignment pin holes on the opposite side of the centering pin hole from the selected bushing. The Uniguide has only two threaded alignment pin holes that can receive alignment pins, so users simply install an alignment pin in each threaded alignment pin hole. Each drill guide is placed on the canting base attachment so that both alignment pins protruding from its base fall within matching recesses in the top surface of the new canting base. Users then connect the canting base to the drill guide using a bolt that passes upward through the canting base into the threaded hole in the base of each drill guide. The assembled drill guide and canting base attachment form a unit that users can hold and guide with just one hand. Additionally, the selected bushing pair will automatically align with the new canting base.

Users can remove the canting shaft from the canting base assembly when drilling non-inclined holes into flat working surfaces. Bushings are used to align drilling tools having bits and shanks of the same diameter.

Edge notches are used to align drilling tools, such as Forstner bits, having bits that are larger than their shanks. The drill bit recess in the front face of the canting base provides space for large diameter bits. When using such tools, users hold the shank against the selected notch and lower the bit to the working surface.

The Uniguide body and segments, by themselves, cannot be adjusted to provide infinite control of depth when using the edge notch. However, infinite depth control can be provided by replacing the two bushing inserts with a threaded shaft that acts as a screw jack. Users can raise Uniguide until the proper depth is reached. Uniguide can thus be used to drill holes to precise depths that are aligned perpendicular to flat working surfaces using, for example, Forstner bits.

When drilling inclined holes into flat working surfaces, users install the canting shaft in the canting base shaft slot with canting angle graduations facing rearward. Canting angles can be set by positioning the shaft so that the selected angle graduation aligns with the top surface of the canting base. Once properly positioned, the canting shaft can be secured using the integral clamp. Users can adjust the canting angle more precisely using, for example, a bevel square. This is especially useful when the selected angle does not coincide with an angle graduation line.

Proper bit alignment for canted holes can be set by striking a line on the working surface that (1) is perpendicular to the plane through which the hole should pass and (2) passes through the marked hole location. Users place the canting base assembly on the working surface so that the drill bit point falls on the marked hole location and the pivot edge of the canting base aligns with the struck line.

When drilling non-inclined holes in cylinders, users can remove canting shafts from the canting base. Users place the canting base assembly (canting base and drill guide) on cylinders so that the groove in its base conforms to the cylinder, then adjust the drill guide for hole depth using the stickup method. Users place the assembly on the cylinder so that the drill bit point meets the marked hole location and advance the drill bit until the drill chuck meets the top bushing.

When drilling inclined holes in cylinders, angle graduations on the canting shaft cannot be used. The canting shaft must be installed in the canting base attachment with the angle graduations facing left or right rather than rearward. The canting base assembly (canting base and drill guide) should be placed on the cylinder so that the deep groove in the canting base conforms to the cylinder. Users must adjust the canting shaft until the top surface of the canting base is canted at the proper angle as measured externally. For example, a user can set a bevel square to the proper angle, then adjust the position of the canting shaft until the top surface of the canting base meets the blade of the bevel square when the bevel square is held against both the cylinder and canting base.

### Dowel Jig Attachment

Users can drill multiple equally spaced-apart and accurately aligned dowel holes to precise depths into the edges and faces of planar workpieces using a new drill guide and new dowel jig attachment disclosed in this CIP application. Dowel holes will be aligned at constant distances from edges, evenly spaced apart by gauged distances, aligned perpendicular to work surfaces, and extended to precise depths.

In these additional embodiments, the dowel jig and alignment system combine to allow users to drill up to five evenly spaced and properly aligned dowel holes at one jig setup location in edges or faces of planar work surfaces. The jig's center and outboard sliding blocks move in unison. The center block slides within a wide, flat-bottomed central groove in the dowel jig. Central sliding block flange grooves are formed in the dowel jig at the bottom of the center sliding block groove. Flanges on the center sliding block engage these flange grooves and prevent vertical movement. Vertical movement of all outboard sliding blocks is also prevented because the locking rod passes through all sliding blocks including the center sliding block.

Outboard sliding blocks have grooved bottom surfaces and slide on grooved top surfaces of dowel jig bodies. Outboard sliding blocks can be shifted left or right incrementally relative to center sliding blocks providing numerous gauged spacing distances between dowel holes. This new dowel jig invention supports standard dowel spacing intervals. It has spacing alignment notches on the back wall of the dowel jig body, center notches on the outboard sliding blocks, and compatible groove widths in the top surfaces of the dowel jig body. For example, one European standard spacing is 32 mm, and one Imperial standard spacing is 1¼ inch. This new dowel jig invention can support either of these standard spacings, but not simultaneously, and numerous non-standard spacings.

Front faces of center and outboard sliding blocks are in the same plane as the drill bit and allow users to accurately position dowel holes at marked locations. This invention provides infinite control over position relative to the thickness of an edge, and numerous gauged lateral spacing distances.

Users drilling dowel holes into an edge of a workpiece can complete these steps:
Install the brace in the dowel jig body;
Mark a line on the edge through which dowel holes are to be drilled (typically, a center line);
Adjust sliding blocks for the desired hole spacing interval;
Mark the location of the dowel hole to be drilled with a point and a line passing through that point that is perpendicular to the workpiece face;
Position the dowel jig on the workpiece so that the center sliding block is aligned with the marked hole location;
Clamp the dowel jig brace to the workpiece;
Adjust the position of the sliding blocks so that their front faces align with the line marked on the workpiece;
Adjust the drill guide for proper depth;
Place the drill guide on a sliding block and drill the hole until the drill chuck meets the drill guide; and
Repeat for each sliding block.

The procedure listed above will have many variations and additional steps in practice but demonstrates one feasible and practical procedure for drilling dowel holes in an edge of a workpiece.

This new dowel jig has no need of sliding adapters; thus, users do not need to maintain a rearward acting force on Multiguide, Triguide, or Uniguide while drilling dowel holes. This change reduces the risk that a dowel hole will be drilled in the wrong location and increases safety since the system is more stable. Additionally, the new dowel jig is thinner and has a lower parts count compared to the original dowel jig. Thus, the new dowel jig represents a betterment over the original dowel jig disclosed in the previous embodiments.

### Method of Manufacture

Multiguide can be composed of hardened steel that can form effective drill bit bushings. Triguide and Uniguide can be composed of metal but will probably be composed largely of plastic. Hard steel bushings can be carried in plastic inserts, or the entire insert can be composed of steel. Threaded rods and nuts will be composed of steel. Other miscellaneous parts will be composed of plastic and produced using injection molding techniques. Some limited post-injection processing may be required for attachments. Both attachments can employ cylindrical metal inserts having external and internal threads that engage threaded metal rods. These inserts are installed in threaded holes in attachments. Both the canting base and dowel jig attachments can be produced using injection molding techniques.

### OTHER CONSIDERATIONS

It is possible to eliminate one alignment pin from the new embodiments. In that case, the single alignment pin would be placed in alignment with the corresponding bushing. Two alignment pins were used in the drill guide disclosed in the previous embodiments to reduce Multiguide plate diameter. Additionally, if a user loses one alignment pin, the second alignment pin will suffice. If only one alignment pin hole is provided, and the user loses the single alignment pin, then the tools cannot be aligned with attachments. Thus, providing two alignment pins provides some redundancy.

What is claimed is:

1. A drilling assist system comprising:
a drill guide configured to guide drill bits and limit hole depth, the drill guide comprising:
a bottom plate configured to locate drill bits relative to working surfaces;
a shaft having threads interrupted by grooves extending upward from the bottom plate,
a top plate moveably attached to the shaft, the top plate being configured to be spaced from the bottom plate and to align drill bits relative to working surfaces; and
a double nut configured to secure the top plate relative to the bottom plate;
a canting base attachment configured to set the drill guide at a tilted orientation relative to flat and curved working surfaces and configured to be removably secured to the drill guide; and
a dowel jig attachment configured to align the drill guide in a plurality of locations spaced from each other for drilling dowel holes in the edges and faces of workpieces.

2. The drilling assist system of claim 1, the bottom plate including a central threaded recess, the canting base attachment including a bolt through-hole configured to be aligned with the threaded recess of the bottom plate, the drilling assist system further comprising a bolt configured to removably secure the canting base attachment to the drill guide via the bolt through-hole and the threaded recess.

3. The drilling assist system of claim 1, the bottom plate including a central threaded recess, the dowel jig attachment including an unthreaded centering pin recess, the drilling assist system further comprising a threaded centering pin configured to be removably secured in the threaded recess and received in the unthreaded centering pin recess of the dowel jig attachment for positioning the drill guide on the dowel jig attachment.

4. The drilling assist system of claim 1, the drill guide further comprising a plurality of threaded alignment pin recesses, the canting base attachment and the dowel jig attachment including a plurality of unthreaded alignment pin recesses, the drilling assist system further comprising a plurality of threaded alignment pins configured to be removably secured in the plurality of threaded alignment pin recesses and received in the plurality of unthreaded alignment pin recesses for aligning the drill guide on the canting base attachment and the dowel jig attachment.

5. The drilling assist system of claim 4, the bottom plate and the top plate including a plurality of holes of different sizes for accommodating drill bits of different sizes, each threaded alignment pin recess being configured to be utilized with two adjacent holes of the plurality of holes of different sizes.

6. A drilling assist system comprising:
a drill guide configured to guide drill bits of a plurality of sizes and limit hole depth, the drill guide comprising:
a bottom plate configured to locate the drill bits relative to working surfaces;
a shaft having threads interrupted by grooves extending upward from the bottom plate,
a top plate configured to be spaced from the bottom plate and align the drill bits relative to the working surfaces;
a double nut configured to secure the top plate relative to the bottom plate; and
a plurality of bushing inserts configured to be removably secured to the bottom plate and the top plate for receiving the drill bits of the plurality of sizes;
a canting base attachment configured to set the drill guide at a tilted orientation relative to flat and curved working surfaces; and
a dowel jig attachment configured to align the drill guide in a plurality of locations spaced from each other for drilling dowel holes in the edges and faces of workpieces.

7. The drilling assist system of claim 6, the bottom plate including a plurality of threaded bushing insert holes, the plurality of bushing inserts being externally threaded and configured to be removably secured in the threaded bushing insert holes for guiding the drill bits.

8. The drilling assist system of claim 7, each of the threaded bushing inserts including an unthreaded central hole, the drilling assist system further comprising a plurality of unthreaded bushings configured to be positioned in the unthreaded holes of the threaded bushing inserts, the unthreaded bushings including a hole that accommodates a drill bit.

9. The drilling assist system of claim 6, the bottom plate and the top plate including edge notches for accommodating large-head drill bits.

10. The drilling assist system of claim 9, the bottom plate and the top plate having triangular shapes, the edge notches being triangular-shaped.

11. A drilling assist system comprising:
a drill guide configured to guide drill bits of a plurality of sizes, the drill guide comprising:
a body configured to engage a workpiece, the body including a central through-hole;
a plurality of threaded bushing inserts configured to be positioned in the central through-hole and aligned with each other for locating the drill bits; and
a plurality of extension segments configured to be selectively attached together and to the body for spacing the plurality of bushing inserts;
a canting base attachment configured to set the drill guide at a tilted orientation relative to flat and cylindrical working surfaces; and
a dowel jig attachment configured to align the drill guide in a plurality of locations spaced from each other for drilling dowel holes in the edges and faces of workpieces.

12. The drilling assist system of claim 11, the body including external threads, the plurality of extension segments including internal threads for engaging the external threads of the body.

13. The drilling assist system of claim 11, the central through-hole and the plurality of bushing inserts including counterclockwise threads for preventing loosening of the plurality of bushing inserts during drilling operations.

14. The drilling assist system of claim 11, the body further comprising threaded alignment pin holes, the drilling assist system further comprising threaded alignment pins configured to be removably secured in the threaded alignment pin holes for aligning the drill guide on the canting base attachment or the dowel jig attachment.

15. The drilling assist system of claim 11, further comprising a lifting shaft configured to be removably secured to the body to space the body above the workpiece.

16. A drilling assist system comprising:
a drill guide configured to guide a drill bit and limit hole depth, the drill guide comprising:
a bottom plate configured to locate the drill bit relative to a working surface;
a shaft having threads interrupted by grooves extending upward from the bottom plate,
a top plate configured to be spaced from the bottom plate and align the drill bit relative to the working surfaces;
a double nut configured to secure the top plate relative to the bottom plate;
a canting base attachment configured to set the drill guide at a tilted orientation relative to flat and cylindrical working surfaces; and
a dowel jig attachment configured to align the drill guide in a plurality of locations spaced from each other for drilling dowel holes in the edges and faces of workpieces, the dowel jig attachment comprising:
a base including a plurality of alignment grooves; and
a plurality of sliding blocks configured to engage the plurality of alignment grooves, each of the plurality of outboard sliding blocks including:
a drill bit recess configured to locate the drill bit relative to a working surface for drilling dowel holes;
a centering pin hole configured to mate the drill guide with the sliding block; and
an alignment pin recess configured to align the drill guide with the sliding block.

17. The drilling assist system of claim 16, the base including a front flange and a rear flange for positioning the dowel jig attachment parallel to a workpiece.

18. The drilling assist system of claim 16, the plurality of alignment grooves including left and right groove sets, one of the plurality of sliding blocks being a center sliding block configured to be positioned between the left and right groove sets.

19. The drilling assist system of claim 18, some of the sliding blocks including alignment notches, the base of the dowel jig attachment including standard spacing notches.

20. The drilling assist system of claim 16, further comprising a jig brace configured to be removably connected to the base of the dowel jig attachment.
